(19) United States
(12) Patent Application Publication
(10) Pub. No.: US 2007/0044036 A1
(43) Pub. Date: Feb. 22, 2007

(54) Information processing apparatus, information processing method, recording medium, and program

(76) Inventors: Yuji Ishimura, Tokyo (JP); Satoshi Kanda, Tokyo (JP)

Correspondence Address: William S. Frommer, Esq.;FROMMER LAWRENCE & HAUG LLP, 745 Fifth Avenue, New York, NY, 10151, US

(21) Appl. No.: 11/506,987

(22) Filed: Aug. 18, 2006

(30) Foreign Application Priority Data
Aug. 19, 2005 (JP) 2005-238280
Aug. 9, 2006 (JP) 2006-216474

(51) Int. Cl. G06F 9/00

(52) U.S. Cl. 715/810; 715/853; 715/854; 715/835

(57) ABSTRACT

There is provided an information processing apparatus capable of handling a plurality of content. The apparatus includes: a display information generator adapted to generate display information related to each of the content; a state manager adapted to manage a display state of the display information; a display layer manager adapted to manage a display layer of the display information; and a display controller adapted to control display of the display information on the basis of the display state managed by the state manager and the display layer of the display information managed by the display layer manager.

### BACKGROUND OF THE INVENTION

1. Field of the Invention

The present invention relates to an information processing apparatus, an information processing method, a recording medium, and a program, and more particularly to an information processing apparatus, an information processing method, a recording medium, and a program all of which are suitable for use in list display of contents each made of a variety of attributes.

2. Description of Related Art

There have been techniques related to a display method for notifying a user of information related to contents, for example, use conditions of contents (for example, Japanese Patent Application Publication Number 2002-312522).

### SUMMARY OF THE INVENTION

However, any related art display method for information related to contents has been unable to ensure the independence and portability of each module or unify the display specifications of different modules in the case of list display of contents made of a variety of attributes.

Accordingly, it is desirable to perform list display of contents made of a variety of attributes. The present invention has been made in view of such a situation.

In accordance with one embodiment of the present invention, there is provided an information processing apparatus capable of handling a plurality of contents. The apparatus includes: display information generation means for generating display information related to each of the contents; state management means for managing a display state of the display information; display layer management means for managing a display layer of the display information; and display control means for controlling display of the display information on the basis of the display state managed by the state management means and the display layer of the display information managed by the display layer management means.

The display information may include, for each display item, a plurality of pieces of display parts information having a tree structure.

The display information or the display parts information may contain an identifier, and the display control means can be adapted to control the display of the display information on the basis of the identifier.

The display information or the display parts information may contain an identifier, and the display control means can be adapted to set a display mode on the basis of the display state managed by the state management means and the display layer of the display information managed by the display layer management means, and set detailed display settings on the basis of the set display mode, whether the display information is selected, and the identifier.

The state management means can be adapted to acquire an operation input by a user, and the display state managed by the state management means may be information indicative of whether the display of the display information is being scrolled, on the basis of the operation input by the user.

In accordance with another embodiment of the present invention, there is provided an information processing method for an information processing apparatus capable of handling a plurality of contents. The method includes: generating display information related to each of the contents; managing a display state of the display information; and controlling display of the display information on the basis of the managed display state and a display layer of the display information.

An identifier may be contained in the display information, and the information processing method may further include searching details of a display form of the display information on the basis of an identifier. In the controlling the display of the display information, the display of the display information is controlled on the basis of the display state and the display layer of the display information as well as the details of the display form of the display information searched for.

In accordance with another embodiment of the present invention, there is provided a program executable by a computer constructed to handle a plurality of contents. The program causing the computer to execute processing includes: generating display information related to each of the contents; managing a display state of the display information; and controlling display of the display information on the basis of the managed display state and a display layer of the display information.

In accordance with any of the embodiments of the present invention, the display information related to the contents is generated, the display state of the display information is managed and the display layer of the display information is managed, and the display of the display information is controlled on the basis of the display state and the display layer of the display information.

As mentioned above, in accordance with the embodiments of the present invention, display information related to contents can be displayed, and particularly when contents made of a variety of attributes are to be displayed in list, easy-to-understand display can be presented while their display forms are unified.

### BRIEF DESCRIPTION OF THE DRAWINGS

The invention will become more readily appreciated and understood from the following detailed description of preferred and specific embodiments of the invention when taken in conjunction with the accompanying drawings, in which:

FIG. 1 is a block diagram showing the construction of an information processing apparatus to which an embodiment of the present invention is applied;

FIG. 2 is a functional block diagram aiding in explaining a module and the like which execute processing for displaying a GUI in the information processing apparatus to which the embodiment of the present invention is applied;

FIG. 3 is a diagram aiding in explaining a plurality of media and contents each of which is a target to be displayed in list;

FIG. 4 is a schematic view aiding in explaining a GUI display screen;

FIG. 5 is a schematic view aiding in explaining a GUI display screen;

FIG. 6 is a schematic view aiding in explaining a GUI display screen;

FIG. 7 is a diagram aiding in explaining the construction of a container;

FIG. 8 is a diagram aiding in explaining individual elements of a container;

FIG. 9 is a diagram aiding in explaining the transition between display states;

FIG. 10 is a table aiding in explaining identifiers;

FIG. 11 is a table aiding in explaining display modes;

FIG. 12 is a table aiding in explaining details of display settings;

FIG. 13 is a schematic view aiding in explaining a GUI display screen;

FIG. 14 is a schematic view aiding in explaining a GUI display screen;

FIG. 15 is a schematic view aiding in explaining a GUI display screen;

FIG. 16 is a schematic view aiding in explaining a GUI display screen;

FIG. 17 is a schematic view aiding in explaining a GUI display screen;

FIG. 18 is a schematic view aiding in explaining a GUI display screen;

FIG. 19 is a schematic view aiding in explaining a GUI display screen;

FIG. 20 is a schematic view aiding in explaining a GUI display screen;

FIG. 21 is a schematic view aiding in explaining a GUI display screen;

FIG. 22 is a flowchart aiding in explaining item holding processing; and

FIG. 23 is a flowchart aiding in explaining display processing.

### DETAILED DESCRIPTION OF THE EMBODIMENTS

An embodiment of the present invention will be described below. First of all, the correspondence between the constituent elements of the present invention and the embodiments described in the description of the embodiments will be described below by way of example. The following description is intended to confirm that the embodiments, which support the present invention, are described in the description of the embodiments. Accordingly, even if there is an embodiment which is mentioned in the description of the embodiments but is not herein described as corresponding to a constituent element of the present invention, this does not indicate that the embodiment does not correspond to the constituent element. Conversely, even if an embodiment is described as corresponding to a constituent element of the present invention, this does not indicate that the embodiment does not correspond to any constituent element other than the constituent element.

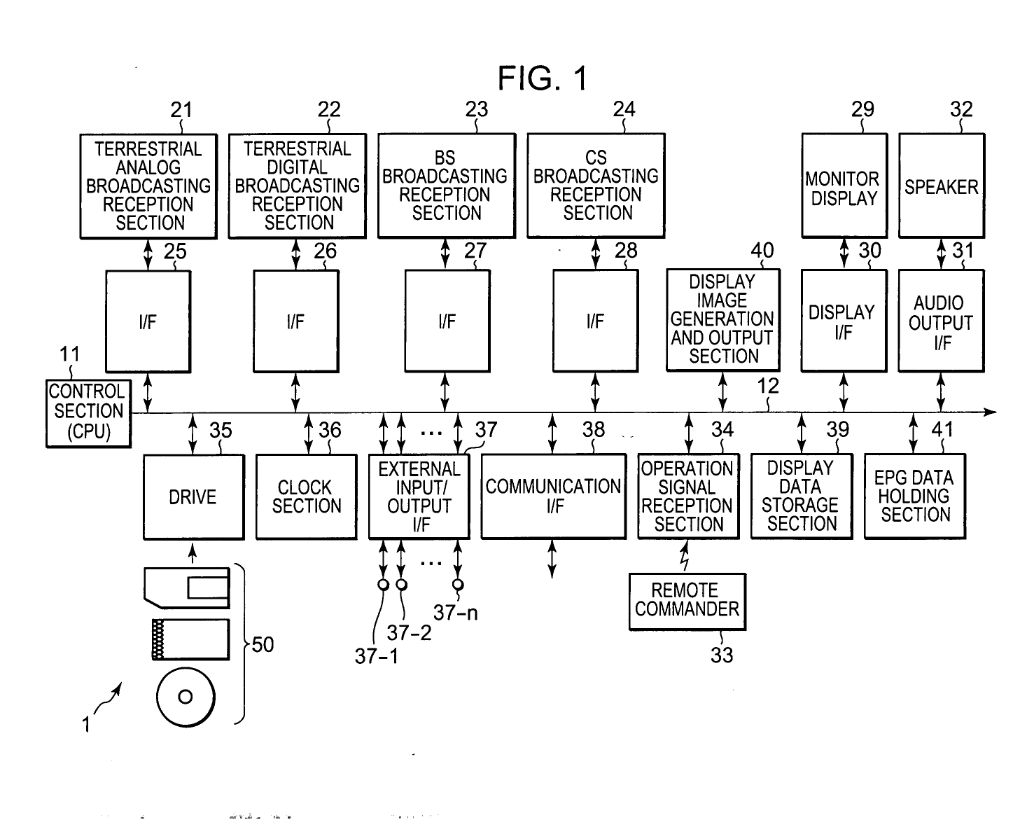

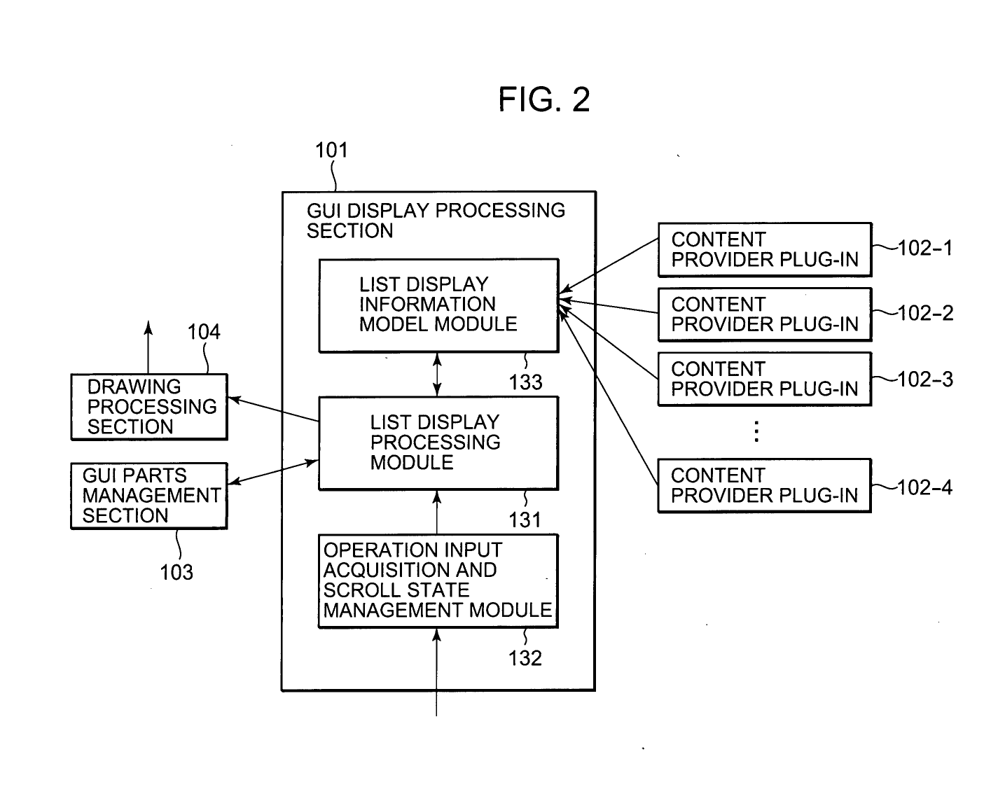

In accordance with one embodiment of the present invention, there is provided an information processing apparatus (for example, an information processing apparatus 1 shown in FIG. 1) capable of handling a plurality of contents. The apparatus includes display information generation means (for example, a content provider plug-in 102 shown in FIG. 2) for generating display information (for example, a container) related to each of the contents, state management means (for example, an operation input acquisition and scroll state management module 132 shown in FIG. 2) for managing a display state of the display information, display layer management means (for example, a list display information model module 133 shown in FIG. 2) for managing a display layer of the display information, and display control means (for example, a list display processing module 131 shown in FIG. 2) for controlling display of the display information on the basis of the display state managed by the state management means and the display layer of the display information managed by the display layer management means.

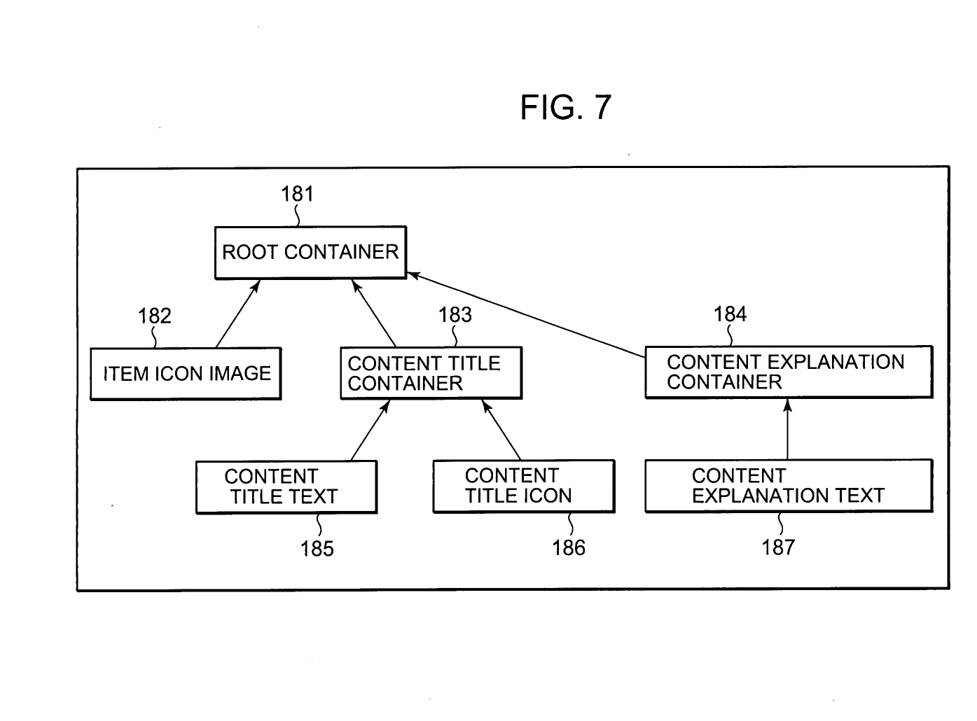

The display information may include for each display item a plurality of pieces of display parts information (for example, GUI parts or items, or containers each containing one or a plurality of items) having a tree structure (for example, a node tree structure extending downward from a root container shown in FIG. 7).

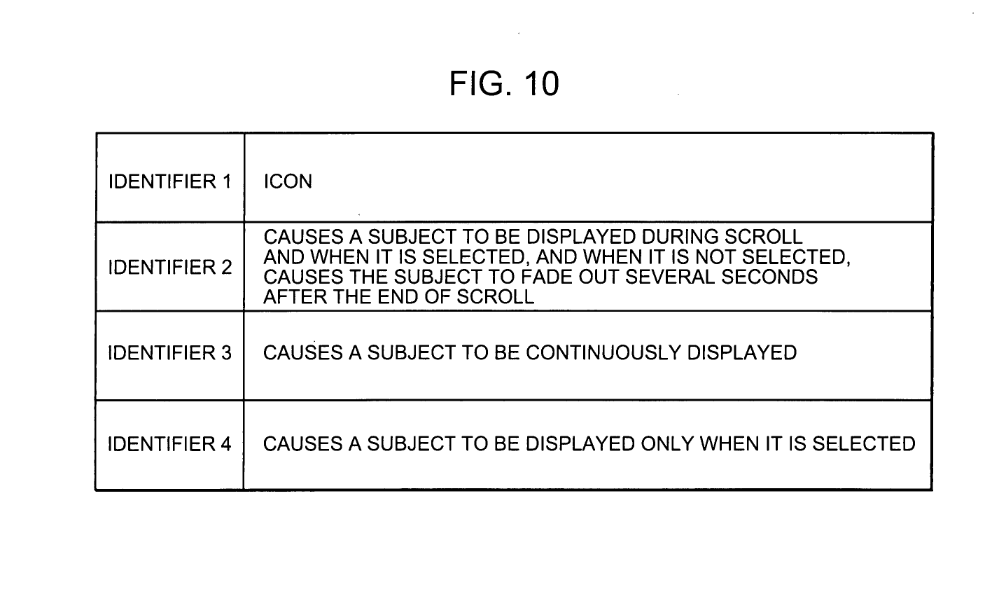

The display information or the display parts information may contain an identifier (for example, an identifier shown in FIG. 10), and the display control means can be adapted to control the display of the display information on the basis of the identifier.

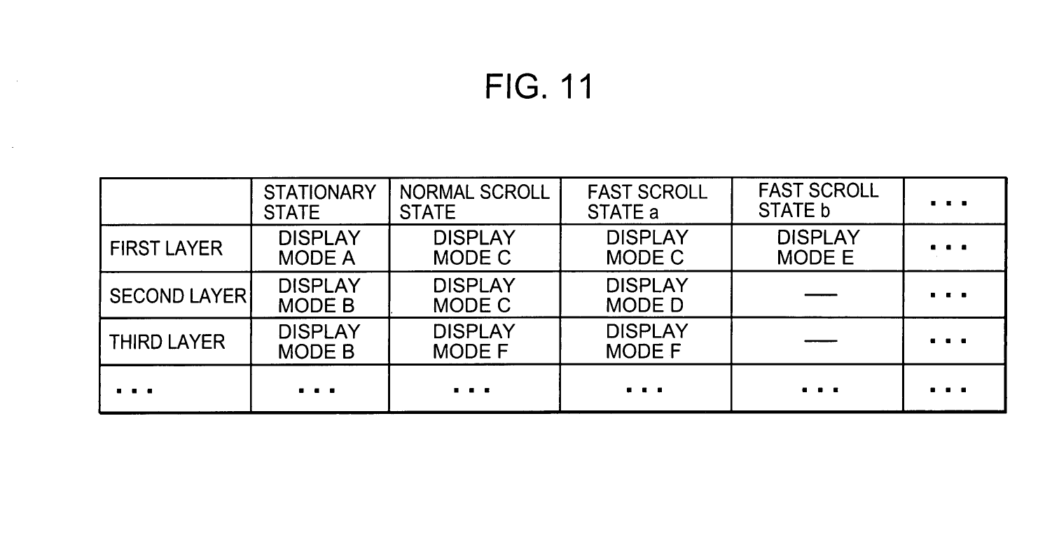

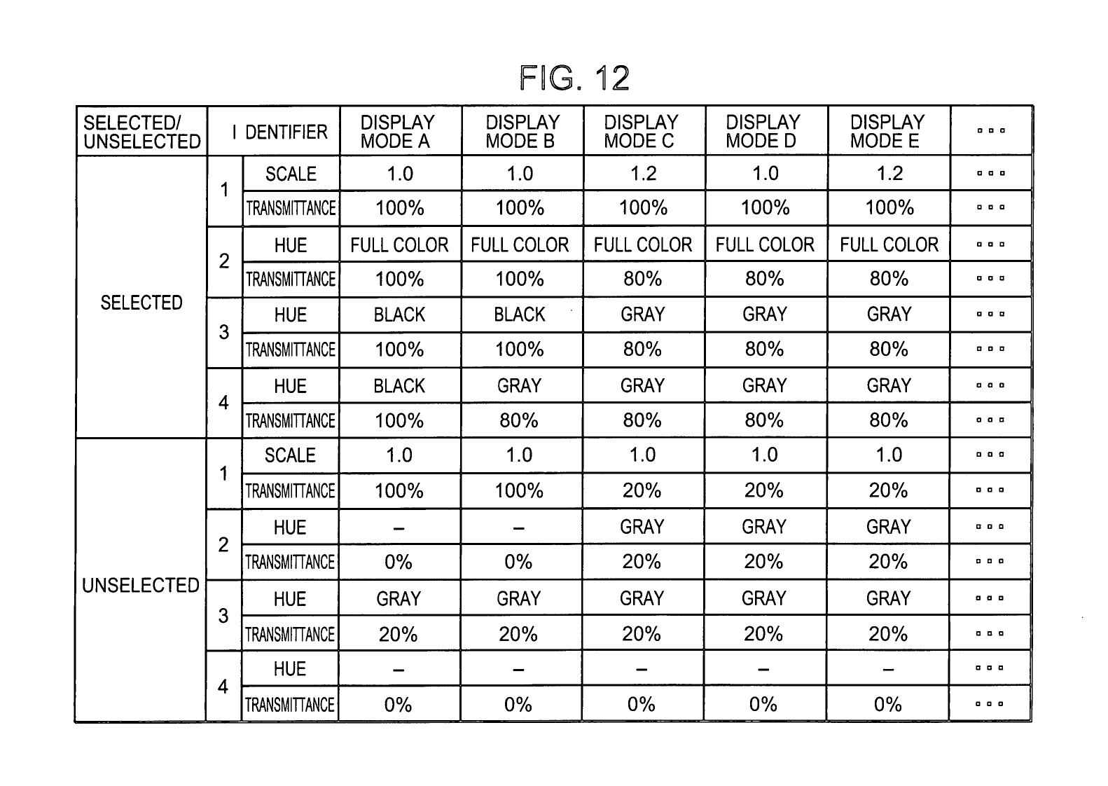

The display information or the display parts information may contain an identifier (for example, an identifier shown in FIG. 10), and the display control means can be adapted to set a display mode (for example, a display mode shown in FIG. 11) on the basis of the display state managed by the state management means and the display layer of the display information managed by the display layer management means, and set detailed display settings (for example, display settings shown in FIG. 12) on the basis of the set display mode, whether the display information is selected, and the identifier.

The state management means can be adapted to acquire an operation input by a user, and the display state managed by the state management means may be information indicative of whether the display of the display information is being scrolled, on the basis of the operation input by the user.

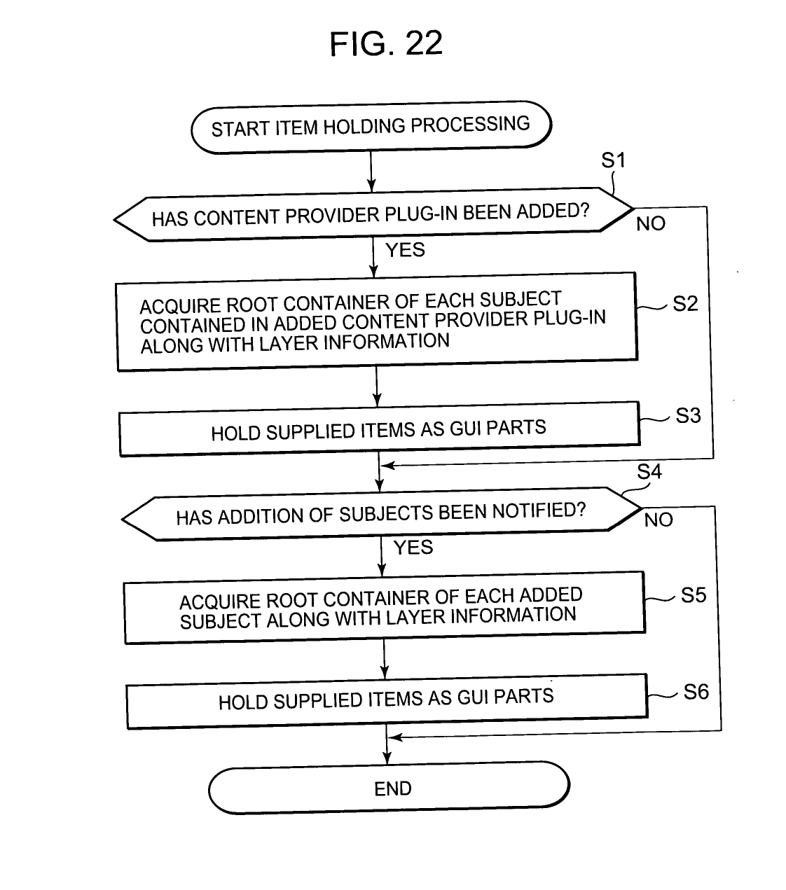

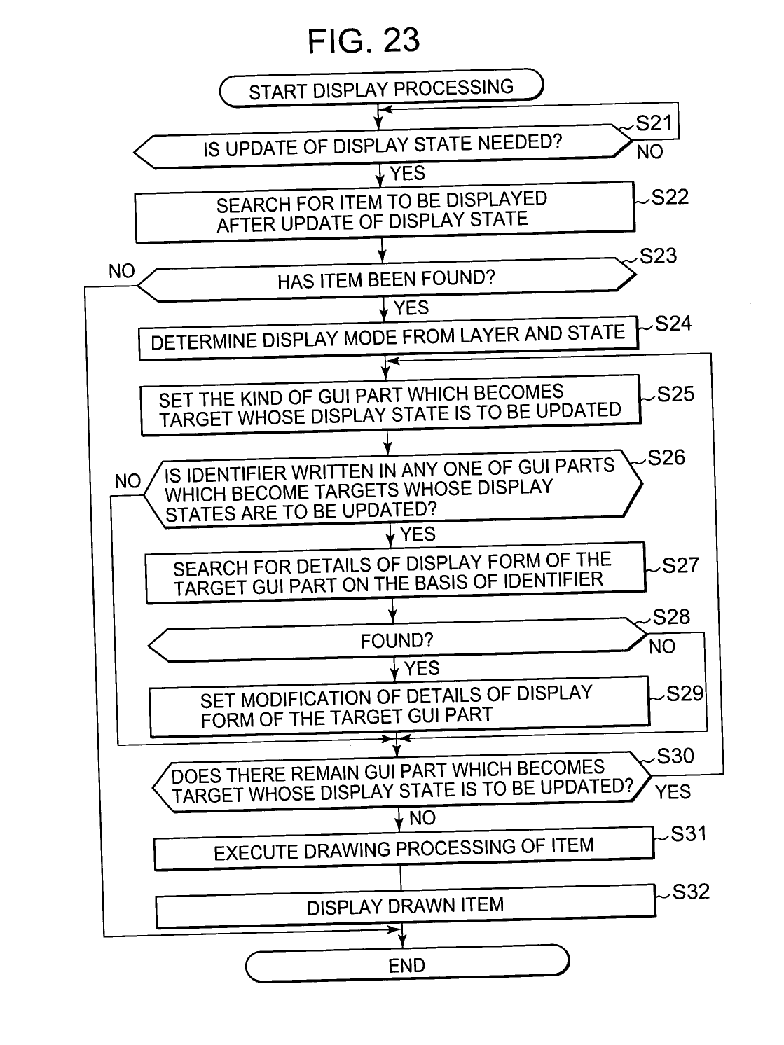

In accordance with another embodiment of the present invention, there is provided an information processing method for an information processing apparatus (for example, the information processing apparatus 1 shown in FIG. 1) capable of handling a plurality of contents, which method includes the steps of generating display information (for example, a container) related to each of the contents (for example, processing which will be mentioned later with reference to FIG. 22), managing a display state of the display information (for example, the processing of step S21 in FIG. 22), and controlling display of the display information on the basis of the managed display state and a display layer of the display information (for example, the processing of step S29 in FIG. 23).

An identifier (for example, an identifier shown in FIG. 10) may be contained in the display information, and the information processing method may further include the step of searching for details of a display form of the display information on the basis of an identifier. The step of controlling the display of the display information may be adapted to control the display of the display information on the basis of the display state and the display layer of the display information as well as the details of the display form of the display information searched for.

In accordance with another embodiment of the present invention, there is provided a program executable by a computer constructed to handle a plurality of contents, the program causing the computer to execute processing including the steps of generating (for example, the processing which will be mentioned later with reference to FIG. 22) display information (for example, a container) related to each of the contents, managing (for example, the processing of step S21 in FIG. 23) a display state of the display information, and controlling (for example, the processing of step S29 in FIG. 23) display of the display information on the basis of the managed display state and a display layer of the display information.

The embodiments of the present invention will be described below with reference to the accompanying drawings.

An information processing apparatus 1 to which an embodiment of the present invention is applied as shown in FIG. 1 has a construction in which various processing sections such as various broadcasting reception sections, an image output display section, an audio output section and an operation input section are connected to a system bus 12 which is connected to a control section 11 made of a microcomputer.

The control section 11 includes a Central Processing Unit (CPU), a program Read Only Memory (ROM) and program Random Access Memory (RAM), a work area Random Access Memory (RAM) and the like, and executes various control processes while using the work area RAM in accordance with a program written in the program ROM or the program RAM.

Executable processing by the control section 11 includes, for example, control of display of GUI screen that will be described below and generation of data for display. The data for display is generated, for example, if a new program is installed, a new content data is acquired, a new EPG data is acquired, or a new device is connected. The generated data may be icon data forming GUI described below, data for channel display, or data for characters. Details of the display of GUI screen and the data for display will be described below.

Provided as the broadcasting reception sections are a terrestrial analog broadcasting reception section 21, a terrestrial digital broadcasting reception section 22, a BS (Broadcasting Satellite) broadcasting reception section 23, and a CS (Communication Satellite) broadcasting reception section 24. The respective broadcasting reception sections 21 to 24 are connected to the system bus 12 via interfaces (I/Fs) 25 to 28. Each of the broadcasting reception sections 21 to 24 selects a broadcasting program corresponding to a channel selection operation inputted by a user via a remote commander 33, from the corresponding one of broadcasting signals received at antennas which are not shown, and transmits image data and audio data of the selected broadcasting program or data received through data broadcasting to the system bus 12 via the corresponding one of the interfaces (I/Fs) 25 to 28.

The terrestrial analog broadcasting reception section 21 selectively receives an existing terrestrial analog television broadcasting signal and outputs an image signal (a video signal) and an audio signal to the system bus 12 via the interface 25. The terrestrial digital broadcasting reception section 22 is compatible with digital television broadcasting, digital audio broadcasting and data broadcasting, and selectively receives and decodes a broadcasting program in response to a channel selection operation by the user and outputs an image signal (a video signal) and an audio signal as well as data such as EPG (Electronic Programming Guide) data to the system bus 12 via the interface 26. The BS broadcasting reception section 23 is compatible with BS television broadcasting, BS audio broadcasting and data broadcasting, and selectively receives and decodes a broadcasting program in response to a channel selection operation by the user and outputs an image signal (a video signal) and an audio signal as well as data such as EPG data to the system bus 12 via the interface 27. The CS broadcasting reception section 24 is compatible with CS television broadcasting, CS audio broadcasting and data broadcasting, and selectively receives and decodes a broadcasting program in response to a channel selection operation by the user and outputs an image signal (a video signal) and an audio signal as well as data such as EPG data to the system bus 12 via the interface 28.

A monitor display 29 made of a CRT (Cathode Ray Tube), an LCD (Liquid Crystal Display) or the like is connected to the system bus 12 via a display interface 30 as the image output display section. A speaker 32 is connected to the system bus 12 via an audio output interface 31 as the audio output section. The remote commander 33 is provided as the operation input section, and an operation signal reception section 34 which receives operation signals from the remote commander 33 is connected to the system bus 12. The remote commander 33 is suitably provided with a right and left direction operation button, an up and down direction operation button, a home button, and a decision button, or may be suitably constructed to permit the user to perform input of similar operations. Specifically, the remote commander 33 is provided with an input device which permits selecting directions and the like to be given on a GUI (Graphical User Interface) screen (which will be described later) which is displayed on the monitor display 29, by the user performing a button operation with various buttons, an up, down, right and left direction cross button, a joystick or the like.

Further connected to the system bus 12 are a drive 35, a clock section 36, an external input/output interface 37, a communication interface 38, a display data storage section 39, a display image generation and output section 40, and an EPG holding section 41.

The drive 35 serves to read and write data from and to a removable media 50 inserted thereinto, such as an optical disc, a magnetic disc, a magneto-optical disc, or a semiconductor memory.

For example, if a new application program and its associated information are recorded on a removable medium 50, the drive 35 reads out from the removable medium 50 the application program and its associated data, and sends to the control section 11 through the system bus 12. The control section 11 installs such new application program and has made it available for execution by the information processing apparatus 1. Alternatively, if replay-able content data such as data of video, audio, image, etc and its associated data are recorded on the removable medium 50, the drive 35 reads out from the removable medium 50 the content data and its associated data, and sends to, for example, an external memory device connected to an external input/output interface 37 through the system bus 12. Furthermore, the content data is recorded in the connected external memory device such that it is available for replay by the information processing apparatus 1.

The clock section 36 provides current time information and calendar information. The clock section 36 is also used for settings of broadcasting program setting and for measurement of various kinds of timer time corresponding to the settings.

The external input/output interface 37 is provided with external input/output terminals 37-1 to 37-n such as a video input/output terminal, an audio input/output terminal and a USB (Universal Serial Bus) terminal, and performs exchange of signals between each of the external input/output terminals 37-1 to 37-n and the system bus 12.

If a new application program to be installed and its associated information is to be provided through the external input/output interface 37, the external input/output interface 37 provides to the new application program and its associated information to the control section 11 through the system 12. The control section 11 installs the new application program and has made it available for execution by the information processing apparatus 1. Alternatively, if replay-able content data and its associated data are provided through the external input/output interface 37, the external input/output interface 37 provides the content data and its associated data to, for example, an external memory device connected to the external input/output interface 37 through the system bus 12. Furthermore, the content data is recorded in the connected external memory device such that it is available for replay by the information processing apparatus 1.

The external input/output interface 37 is adapted to be connectable to, for example, the external memory device, a digital still camera, digital video camera, or other information processing apparatus having various functionalities. The information processing apparatus 1 is capable of transmitting and receiving necessary information to/from another apparatus that connected to the external input/output interface 37, and of controlling a functionality of another apparatus connected thereto.

The communication interface 38 is connected to a communication line, and is used for transmitting a response signal to a predetermined address or acquiring data broadcasting content from a server through a network when a data broadcasting program is an interactive program. In addition, the communication interface 38 is also capable of loading data such as web content via the Internet and sending out predetermined information via the Internet.

If a new application program to be installed and its associated information is to be provided through the communication interface 38, the communication interface 38 provides to the new application program and its associated information to the control section 11 through the system 12. The control section 11 installs the new application program and has made it available for execution by the information processing apparatus 1. Alternatively, if replay-able content data and its associated data are provided through the communication interface 38, the communication interface 38 provides the content data and its associated data to, for example, an external memory device connected to the external input/output interface 37 through the system bus 12. Furthermore, the content data is recorded in the connected external memory device such that it is available for replay by the information processing apparatus 1.

The display data storage section 39 stores data on icons which constitute a GUI which will be described later, channel display data, and other display data such as character data.

There are cases where presentation of unknown content is needed for GUI. For example, such cases include a case where types of content to be displayed in GUI increase or decrease depending on an executable application in the information processing apparatus 1, or more specifically such as a case where a new EPG is held in the EPG data holding section 41, a case where a received broadcasting program is recorded, a case where new contents such as still images, moving picture images, or music is acquired from another apparatus connected to the external input/output interface 37. Furthermore, presentation of unknown functionality or operation is needed for GUI in such cases where the number of executable applications in the information processing apparatus 1 increase or decrease, or where the information processing apparatus 1 is connected to other apparatus and controls the functionality of the other apparatus connected thereto. The display data storage section 39 is capable of receiving the provided display data, which is newly generated by the control section 11 as needed, and storing therein. The display data include, for example, display icon data that forms GUI, which will be described below, channel display data, or other character data.

The display image generation and output section 40 generates an image to be displayed on the monitor display 29, under the control of the control section 11. The display image generation and output section 40 stores image data and music data received by the broadcasting reception sections 21 to 24 into its built-in output buffer. In addition, the display image generation and output section 40 is supplied with data on GUI parts corresponding to characters, symbols and the like for GUI display, and stores the supplied data into its built-in on-screen buffer as On Screen Display (OSD) data. The on screen display data is data to be displayed superposed on an image of reproduced video displayed on the screen of the monitor display 29. Specifically, since the GUI is displayed superposed on a reproduced image as OSD, the image of reproduced video is seen through the GUI display.

Then, the display image generation and output section 40 supplies data obtained by synthesizing the data stored in the output buffer and the on screen display data stored in the on-screen buffer to the monitor display 29 via the display interface 30.

The EPG holding section 41 holds in its built-in memory electronic program guide data (EPG data) supplied from each of the broadcasting reception sections 21 to 24 via the corresponding one of the interfaces (I/Fs) 25 to 28 and the system bus 12. EPG data in terrestrial analog broadcasting is superposed on vertical blanking periods of a television broadcasting signal, while EPG data in data broadcasting is sent by data broadcasting. Such EPG data includes data such as the names of broadcasting stations of individual broadcasting programs as well as the title, the starting and ending time, the cast and the genre of each of the broadcasting programs. The EPG data held in the EPG holding section 41 is updated into the latest data.

In addition, the EPG data, instead of using EPG data transmitted superposed on a broadcasting signal, may also use EPG data acquired from an EPG data provider server connected to the Internet through access to the EPG data provider server by using, for example, the communication interface 38.

Applications executable in the information processing apparatus 1 shown in FIG. 1 and contents usable in each of the applications are displayed in list on the monitor display 29, and the user can perform input of operations by using the remote commander 33 while referring to the list display, i.e., a GUI (Graphical User Interface).

If the kinds of contents to be displayed in the GUI by the applications executable in the information processing apparatus 1 shown in FIG. 1, for example, if a new EPG is held in the EPG holding section 41 or a received broadcasting program is recorded or still or moving images or music contents are newly acquired another apparatus connected to the external input/output interface 37, the GUI needs to perform unknown content representation. Furthermore, presentation of unknown functionality or operation is needed for GUI in such cases where the number of executable applications in the information processing apparatus 1 increase or decrease, or where the information processing apparatus 1 is connected to other apparatus and controls functionality of the other apparatus connected thereto. A plurality of applications executable in the information processing apparatus 1 are prepared, and in order that contents which would be newly generated or deleted be appropriately represented in each application executable or each application software by a unified display method, it is useful to construct the main part of an application for controlling the list display by managing modifications applied to display states by operation input and the like and performing calls of functions associated with the contents, and to construct a module (hereinafter referred to as a plug-in) for managing the contents and generating GUI parts peculiar to the contents, as well as to construct the entire display system by using the main part of the application and the module (the plug-in).

In the entire display system of the software constructed with the module, if the unity of a display method is to be realized, it is necessary to enable the plug-in to freely construct a GUI part and to enable the main part of the application to appropriately identify a GUI part which becomes a target whose display state is to be modified when a transition occurs in the display state, from among GUI parts acquired from the plug-in.

Accordingly, in the information processing apparatus 1 to which the embodiment of the present invention is applied, a plurality of primitive semantic elements which would be contained in a GUI representative of content are defined, and identifier setting rules for a container part which contains one or a plurality of GUI parts corresponding to each of the defined semantic elements are defined. Then, the main part of the application for performing list display of content modifies the display state of a GUI part identified by an identifier, on the basis of specifications unified in accordance with the internal state of the module. In this manner, it is possible to exclude the direct dependence between modules constructing the entire display system and ensure portability, and to realize the unity of display specifications.

FIG. 2 is a functional block diagram aiding in explaining a function which realizes the above-mentioned display.

A GUI display processing section 101 corresponds to the main part of the application for performing list display of contents and includes the list display processing module 131, the operation input acquisition and scroll state management module 132, and the list display information model module 133, and executes various kinds of processing related to GUI display such as management of display methods according to modifications of display states.

Each of content provider plug-ins 102-1 to 102-n is a module for managing contents and generating GUI parts representative of the contents in a respective one of applications such as an application for setting the apparatus, an application for managing and displaying contents such as photographs and video, and an application for performing recording setting.

In the following description, the content provider plug-in 102-1 to 102-n are referred to simply as a content provider plug-in 102 if there is no need to refer them separately.

A new content provider plug-in 102-1 is set up if new application executable in the information processing apparatus 1 is installed, or if other apparatus is connected to the information processing apparatus 1 and the connected other apparatus is available to be controlled by the information processing apparatus 1. For example, if a new application executable in the information processing apparatus 1 is to be installed, the corresponding content provider plug-in 102 may be a function contained in the application program, or may be provided with the application program, or provided in any other method. Furthermore, if other apparatus is connected to the information processing apparatus 1 and the information processing apparatus 1 is capable of controlling a function of the connected other apparatus, the corresponding content provider plug-in 102 may be provided from the connected other apparatus through the external input/output interface 37, or provided through any other method.

In other words, the content provider plug-ins 102-1 to 102-n are provided in response to corresponding functions of the information processing apparatus 1, respectively.

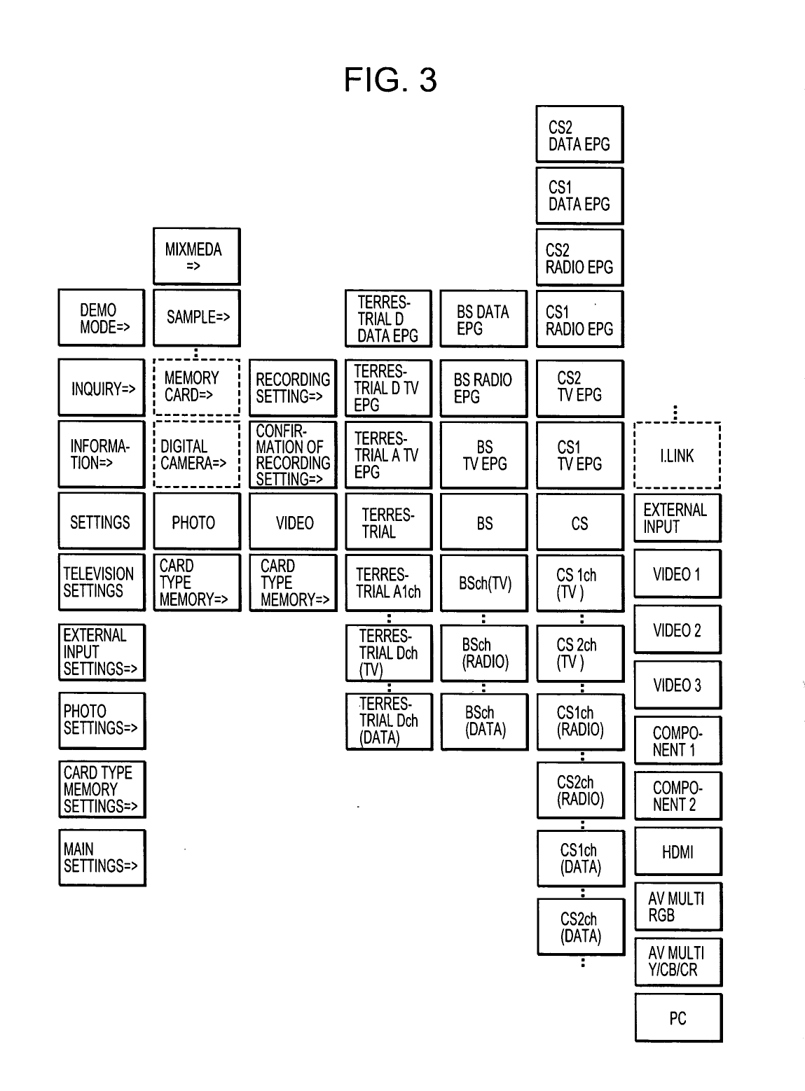

A plurality of media which are targets to be displayed in list when the respective content provider plug-ins 102-1 to 102-n are set up will be described later with reference to FIG. 3.

A GUI parts management section 103 is supplied with and holds GUI parts which are respectively generated by the content provider plug-ins 102-1 to 102-n and whose displays are controlled by the GUI display processing section 101. When the GUI display processing section 101 requests a GUI part from the GUI parts management section 103, the GUI parts management section 103 supplies the requested GUI part to the GUI display processing section 101.

A drawing processing section 104 draws and outputs respective items as GUIs corresponding to respective contents on the basis of display forms set in the GUI display processing section 101. Containers containing GUI parts represent the items.

The list display processing module 131, the operation input acquisition and scroll state management module 132, and the list display information model module 133 in the GUI display processing section 101 will be described below.

The list display processing module 131 is a module for executing processing for displaying contents in list, and receives root containers of respective contents, each of which contains a GUI part which is an item to be displayed, from the content provider plug-ins 102-1 to 102-n via the list display information model module 133, and holds GUI parts for itself in the GUI parts management section 103 as items.

The operation input acquisition and scroll state management module 132 acquires a key input from the user or an event from another module, and modifies its internal state (scroll state). The list display information model module 133 is supplied with root containers and items contained in the root containers (or containers containing the items) from the content provider plug-ins 102-1 to 102-n, and manages the display layers of the supplied root containers. The list display processing module 131 determines settings and a display mode of a GUI screen and modifies settings such as colors, transmittances or display magnifications of GUI parts on the basis of the internal state managed by the operation input acquisition and scroll state management module 132 and the display layers managed by the list display information model module 133.

At this time, the list display processing module 131 determines whether predetermined identifiers are written in the respective GUI parts. If the predetermined identifiers are written, the list display processing module 131 refers to a table which indicates details of display settings determined according to display modes and whether items are selected or unselected as shown in FIG. 12 which will be mentioned later, and modifies colors, transmittances, display magnifications or the like of the respective GUI parts.

The list display processing module 131 reads out the GUI parts held in the GUI parts management section 103, modifies settings such as the colors, the transmittances, the display magnifications or the like of the respective GUI parts, and supplies the modified settings to the drawing processing section 104 and cause it to perform drawing.

Although the function mentioned above with reference to FIG. 2 has been described as being realized by various programs executed in the control section 11, it goes without saying that the present invention can also be realized by hardware having the function shown in FIG. 2.

The user of the information processing apparatus 1 can readily select broadcasting media or broadcasting programs to be received, select other functions, and refer to explanations, information and the like regarding the respective programs and functions by operating predetermined buttons and keys of the remote commander 33 while referring GUIs displayed on the monitor display 29 by the respective functions mentioned above with reference to FIG. 2.

As described above, the content provider plug-ins 102-1 to 102-n are provided in response to the corresponding functions of the information processing apparatus 1, respectively. Such a mechanism allows providing a GUI screen in response to the respective state even in the cases where a new function is added or one of the functions is removed. Furthermore, even in other apparatus having a different function from that of the information processing apparatus 1, the similar GUI display screen as the information processing apparatus 1 may be displayed if the function explained with FIG. 2 can be realized and the content provider plug-in 102 is provided in response to the corresponding function that can be realized by hardware configuration of its own or the application program installed.

In other words, the GUI display screen that can be realized by the function shown in FIG. 2 may be commonly provided among different apparatuses having different functions. Accordingly, the common GUI display screen can be provided in various apparatuses, thereby suppressing development cost. Furthermore, it is also advantageous for a user since the same or similar operation can be used to select a function or content in various apparatuses.

A plurality of media and contents which are targets to be displayed in list by setting the content provider plug-ins 102-1 to 102-n shown in FIG. 2 are, for example, as shown in FIG. 3.

Icons to be displayed on the screen of the monitor display 29 include category icons which respectively represent categories of processing functions and processing targets such as broadcasting media, setting functions and external inputs, and item icons each of which represents a processing function item and an item of a processing target content belonging to a respective one of the categories. In the present embodiment, SETTINGS, PHOTO, VIDEO, TERRESTRIAL BROADCASTING, BS BROADCASTING, CS BROADCASTING and EXTERNAL INPUT are set as the categories represented by the respective category icons, and data of these category icons are stored in the display data storage section 39 by the processing of the GUI parts management section 103.

The number of the item icons, which respectively represent items of processing function items and items of processing target contents in each of the categories differs among the categories. The above-mentioned categories such as SETTINGS, PHOTO and VIDEO are arranged in the horizontal direction, and a plurality of items belonging to each of the categories are arranged to align in the upward and downward directions from the corresponding one of the categories. In FIG. 3, among the items belonging to some of the categories, items in each of which symbol “=>” is written indicate that they are provided with items in lower layers. These items include items of utilities (hereinafter referred to as utility items), logic folders and the like.

For example, items of only logic folders belong to the category “SETTINGS”. The category “SETTINGS” is provided with a plurality of items such as TELEVISION SETTINGS, EXTERNAL INPUT SETTINGS and PHOTO SETTINGS, and each of the logic folders is provided with lower-layer items. The category “PHOTO” is provided with items “CARD TYPE MEMORY”, “SAMPLE” and “MIXMEDIA” as the utility items. The item icon of each of the utility items is displayed only when the corresponding medium is arranged. The category “VIDEO” is provided with items such as RECORDING SETTING and CONFIRMATION OF RECORDING SETTING as items of logic folders, and the item “CARD TYPE MEMORY” as the utility item.

Each of the categories of the broadcasting media is provided with utility items and broadcasting channel items, and the utility items are written above the title of each of the categories, while the broadcasting channel items for use as function completion items are written below the same. The broadcasting channel items for use as function completion items belong to each of the categories of the broadcasting media are grouped by broadcasting target, such as television, radio and data. Namely, selection target items belonging to each of the categories of the broadcasting media are grouped by broadcasting target which is an attribute related to each of the selection target items.

Namely, the category of terrestrial broadcasting media includes a group of terrestrial analog broadcasting channels, a group of terrestrial digital broadcasting television channels, and a group of data broadcasting of terrestrial digital broadcasting. TERRESTRIAL A1 ch indicates one of the terrestrial digital broadcasting television channels, TERRESTRIAL Dch(TV) indicates one of the terrestrial digital broadcasting television channels, and TERRESTRIAL Dch(DATA) indicates one channel of the data broadcasting of terrestrial digital broadcasting. The category of BS broadcasting media includes a group of BS broadcasting television channels, a group of BS broadcasting radio channels, and a group of data broadcasting of terrestrial digital broadcasting. BSch(TV) indicates one of the BS broadcasting television channels, BSch(RADIO) indicates one of the BS broadcasting radio channels, and BSch(DATA) indicates one channel of the data broadcasting of terrestrial digital broadcasting. The category of CS broadcasting media includes two broadcasting media CS1 and CS2, which include a group of CS1 broadcasting television channels (one of which is CS1ch(TV)), a group of CS2 broadcasting television channels (one of which is CS2ch(TV)), a group of CS1 broadcasting television channels (one of which is CS1ch(TV)), a group of CS1 broadcasting radio channels (one of which is CS1ch(RADIO)), a group of CS2 broadcasting radio channels (one of which is CS2ch(RADIO)), a group of data broadcasting of CS1 broadcasting (one channel of which is CS1ch(DATA)), and a group of data broadcasting of CS2 broadcasting (one channel of which is CS2ch(DATA)). CS1ch(TV) indicates one of the CS1 broadcasting television channels, CS2ch(TV) indicates one of the CS2 broadcasting television channels, CS1ch(TV) is one of the CS1 broadcasting television channels, CS1ch(RADIO) is one of the CS1 broadcasting radio channels, CS2ch(RADIO) is one of the CS2 broadcasting radio channels, CS1ch(DATA) is one channel of the data broadcasting of CS1 broadcasting, and CS2ch(DATA) is one of the data broadcasting of CS2 broadcasting.

Regarding EPGs which are the utility items in each of the categories of the broadcasting media, EPGs corresponding to each of the groups are prepared. For example, TERRESTRIAL A TV EPG is an EPG for terrestrial analog television broadcasting, TERRESTRIAL D TV EPG is an EPG for terrestrial digital television broadcasting, and TERRESTRIAL D DATA EPG is an EPG for data broadcasting of terrestrial digital broadcasting.

The category of EXTERNAL INPUT includes input switching items such as VIDEO 1, VIDEO 2 and COMPONENT 1 as its function completion items.

As mentioned with reference to FIG. 3, the structure in which items such as a plurality of processing function items and processing target content items correspond to each of a plurality of categories is reflected to display on the screen of the monitor display 29. Namely, on the screen of the monitor display 29, the respective categories shown in FIG. 3 are displayed by corresponding icons (hereinafter referred to as the category icons), and the respective items shown in FIG. 3 are displayed by corresponding icons (hereinafter referred to as the item icons). Namely, FIG. 3 shows the relationship between the category icons and the item icons.

The relationship between the category icons and the item icons is merely one example, and it goes without saying that the construction shown in FIG. 3 does not restrict the kinds of constructions to which the present invention is applicable and the present invention can be applied to various other constructions provided with different categories and different items.

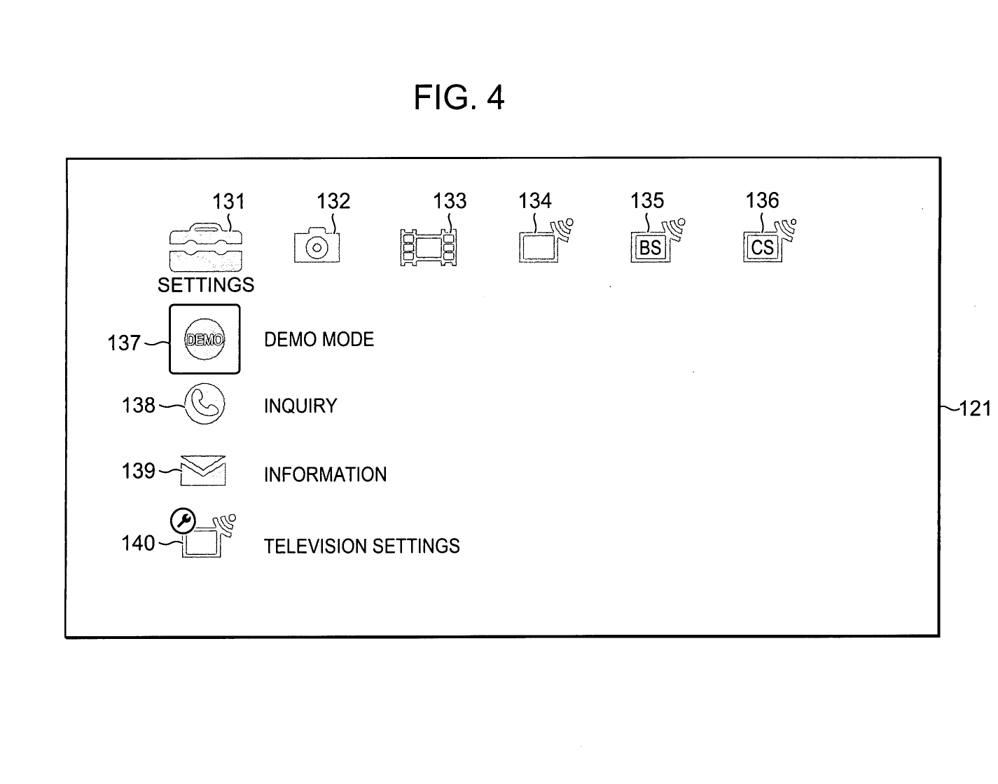

FIG. 4 shows one example of an initial menu screen of a GUI screen displayed on the monitor display 29 in the present embodiment. A GUI screen 121 is displayed superposed on or is erased from an image displayed on the monitor display 29 by the home button provided on the remote commander 33 being operated by the user. Displayed on the GUI screen 121 is a two-dimensional arrangement in which a category icon arrangement including a plurality of category icons arranged in a horizontal line intersects with an item icon arrangement including a plurality of item icons arranged in a vertical line.

The above-mentioned category icons are arranged in the category icon arrangement. Namely, in FIG. 4, an icon 131 formed by a pattern of a tool box represents a category icon indicative of SETTINGS, an icon 132 formed by a pattern of a camera represents a category icon indicative of PHOTO, an icon 133 formed by a pattern of film represents a category icon indicative of VIDEO, an icon 134 including a pattern of a television set and an antenna represents a category icon indicative of TERRESTRIAL DIGITAL BROADCASTING, an icon 135 including the characters “BS” represents a category icon indicative of BS DIGITAL BROADCASTING, and an icon 136 including the characters “CS” represents a category icon indicative of CS DIGITAL BROADCASTING

As shown in FIG. 4, the category icon arrangement is displayed to extend in the horizontal direction at a location slightly higher than the vertical center of the GUI screen 121 displayed on the monitor display 29, and any one of the category icons is continuously selected. The item icon arrangement is displayed in association with only a category icon which is selected. Namely, the item icon arrangement is an arrangement of a plurality of item icons which respectively represent a plurality of items belonging to a category corresponding to a category icon which is selected. In the example shown in FIG. 4, since the SETTINGS category icon 131 is selected, item icons belonging to the SETTINGS category icon 131, i.e., a DEMO MODE item icon 137, an INQUIRY item icon 138, an INFORMATION item icon 139 and a TELEVISION SETTINGS item icon 140, are displayed to be arranged in the vertical direction.

The item icons which are displayed to be arranged in the vertical direction with respect to the selected category icon in the above-mentioned manner represent items located directly below the category icon, and are called item icons in the first layer.

If the user is to change the selection of the item icons belonging to the SETTINGS category by using the remote commander 33 (for example, the user specifies an up or down direction), the locations of all item icons belonging to the SETTINGS category are changed and another item icon is selected and determined so as to execute the corresponding function. In addition, an item icon which is selected with a lower layer being displayable is continuously displayed directly below the SETTINGS category icon.

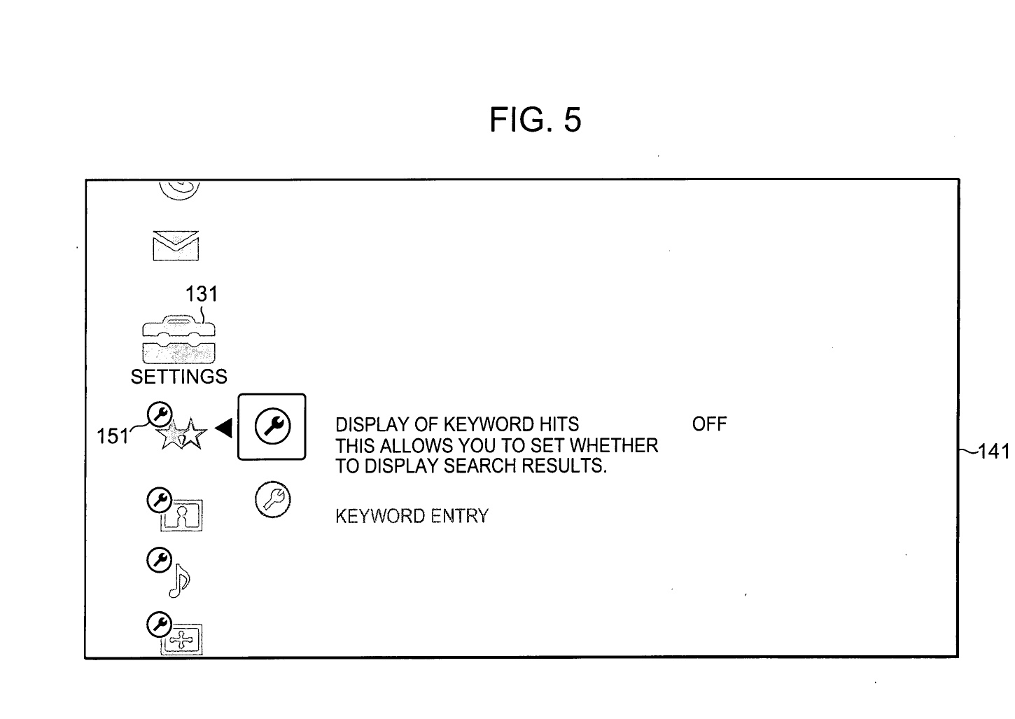

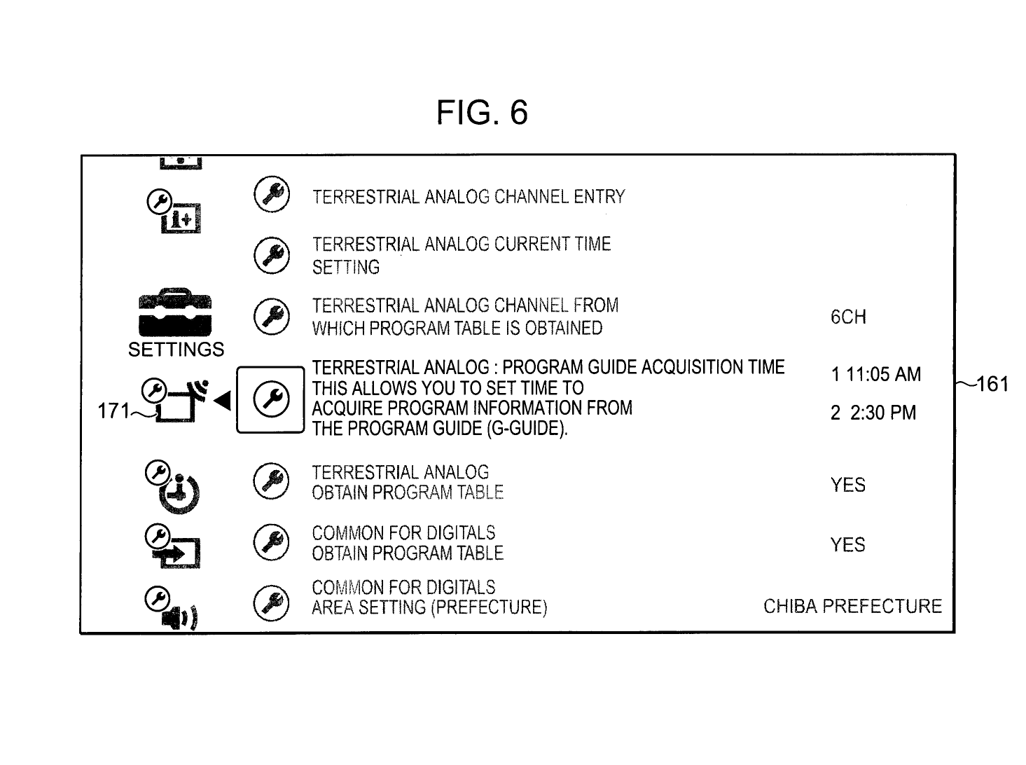

If any one of the item icons is selected and determined, the item icon arrangement is moved to the left on the screen and item icons in the second layer associated with an item corresponding to the selected and determined item icon are displayed as shown on a GUI screen 141 in FIG. 5 or on a GUI screen 161 in FIG. 6.

On the GUI screen 141 shown in FIG. 5, only two item icons in the second layer corresponding to a selected item icon 151 are displayed, but on the GUI screen 161 shown in FIG. 6, a large number of item icons in the second layer corresponding to a selected item icon 171 are displayed. In the case of the GUI screen 161, the user may perform a so-called scroll operation to display the desired item icon from the item icons in the second layer.

A plurality of kinds of contents such as still images, video moving images, music and television programs can be displayed in list on the screen in the above-mentioned manner, and GUI parts and the construction thereof which represent such contents differ among the contents. The display of any of the above-mentioned icons and an explanation and the like thereof is modified according to its selected state and the like.

A collection of category icons and item icons as well as explanations to be displayed along with the category and item icons is herein referred to as a container, and GUI parts such as icons and texts are herein referred to as items.

As shown in FIG. 7, a container includes a plurality of items having a relationship having a structure like a node tree.

In the example shown in FIG. 7, a root container 181 is able to contain a plurality of containers, icons and texts, and an item icon image 182, a content title container 183 and a content explanation container 184 hang from the root container 181. Furthermore, a content title text 185 and a content title icon 186 hang from the content title container 183, and a content explanation text 187 hangs from the content explanation container 184.

The structure hanging from the root container 181 can be freely set by content providers. Namely, the kinds and number of GUI parts representative of contents generated by the respective content provider plug-ins 102-1 to 102-n, differ among target contents. Namely, the root container 181 may not contain all the containers and items shown in FIG. 7, or may also contain other items such as images or texts or other containers in addition to those shown in FIG. 7, and each of the containers may also be constructed to contain texts and icons having different data constructions.

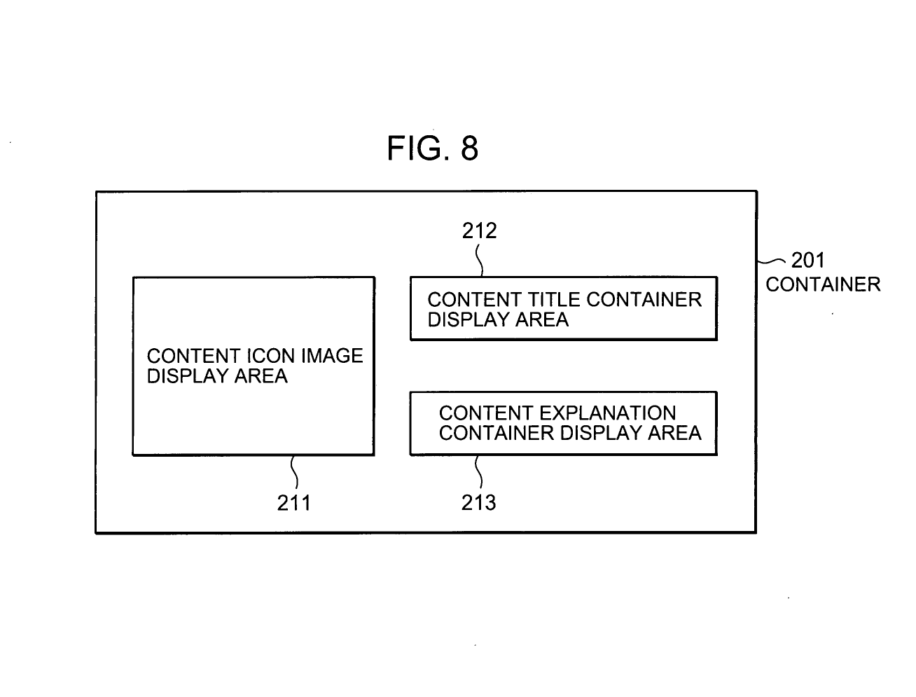

FIG. 8 shows an example of a display form of a container.

As shown in FIG. 8, for example, a content icon image display area 211, a content title container display area 212 and a content explanation container display area 213 are provided in the display area of a container 201, so that the items located below the root container 181 shown in FIG. 7 are displayed in the same. All of these items may be arranged laterally in the display area of the container 201, and the arrangement of items in each of the areas 211, 212 and 213 within the display area of the container 201 may also be modified according to the layer in which the root container 181 is present.

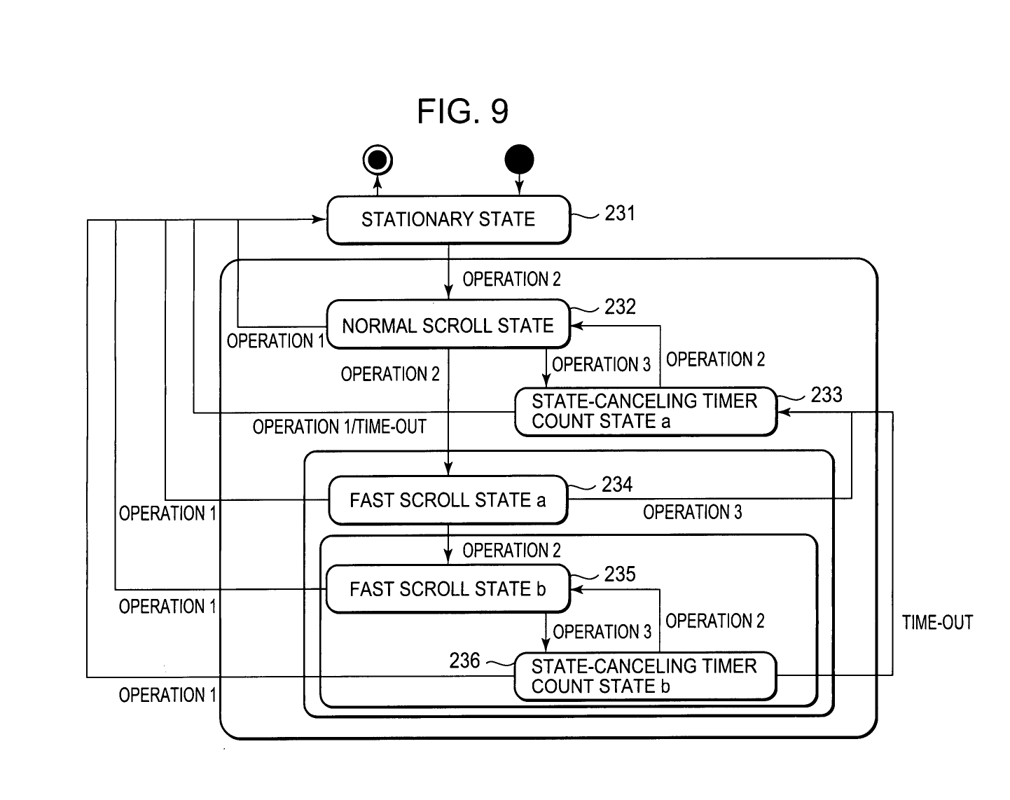

Display states and transitions thereamong will be described below with reference to FIG. 9.

In the state chart shown in FIG. 9, operation 1 denotes an operation input indicating a command to change layers or categories, operation 2 denotes a depression of a scroll button, and operation 3 denotes a release of the scroll button (a stop of the depression of the scroll button).

The state in which the GUI screen 121 is displayed by an operation of, for example, the home button mentioned previously with reference to FIG. 4 is a stationary state 231.

If the scroll button is depressed (operation 2) during the stationary state 231, the stationary state 231 changes to a normal scroll state 232 and the display position of the item icons of a presently selected category is modified. When the depressed scroll button is released (operation 3), the state transitions to a state-canceling timer count state a 233, and if the scroll button is depressed (operation 2) during timer count, i.e., within a predetermined time after the release of the scroll button, the state again changes to the normal scroll state 232. However, if a command to change layers or categories is inputted (operation 1) or a time-out occurs during the timer count, i.e., within the predetermined time after the release of the scroll button, the state returns to the stationary state 231.

If the depressed scroll button continues to be depressed (operation 2) without being released during the normal scroll state 232, the state changes to a fast scroll state a 234, in which the display position of the item icons of the presently selected category is modified faster than is during the normal scroll state 232. If the scroll button is released (operation 3) at this time, the state transitions to the state-canceling timer count state a 233. If a command to change layers or categories is inputted (operation 1) during the fast scroll state a 234, the state returns to the stationary state 231. If the depressed scroll button continues to be depressed (operation 2) without being released during the fast scroll state a 234, the state changes to a fast scroll state b 235 in which the display position of the item icons of the presently selected category is modified far faster than is during the normal scroll state 232.

If the depressed scroll button continues to be depressed without being released during the fast scroll state b 235, the state remains the fast scroll state. When the depressed scroll button is released (operation 3) during the fast scroll state b 235, the state transitions to a state-canceling timer count state b 236, and if the scroll button is depressed (operation 2) during timer count, i.e., within a predetermined time after the release of the scroll button, the state again changes to the fast scroll state b 235. However, if a command to change layers or categories is inputted (operation 1) within the predetermined time after the release of the scroll button, the state returns to the stationary state 231. If a time-out occurs within the predetermined time after the release of the scroll button, the state transitions to the state-canceling timer count state a 233.

Accordingly, since the user can cause the GUI screen to appropriately transition from one to another of the display states, even if a large number of item icons are prepared, the user can readily find the desired item icon by using a scroll of the desired speed.

In addition, items to be displayed differ among the stationary state and the scrolling states.

Specifically, there is information, such as the title of a broadcasting program, which is desired to be displayed during scroll according to the content and the like of text contained in a container, whereas there is information, such as an explanation of the content of a broadcasting program, which need not be displayed during scroll, because the user cannot easily read it during scroll. For example, explanations or the like of the contents of broadcasting programs in many causes need only to be displayed merely when containers are selected. In contrast, it is preferable that icons be continuously displayed, and there is also information of the kind other than icons which is preferably continuously displayed. It is preferable, therefore, that whether to enable or disable display for each display state can be appropriately selected by content providers.

For this reason, in the present embodiment, an identifier can be written into each item, which identifier can specify its display form on the GUI screen on the basis of the display state of the item or whether the item is selected.

As shown in FIG. 10 by way of example, an item in which identifier 1 is set is identified as an icon by the list display processing module 131. An item in which identifier 2 is set is controlled by the list display processing module 131 to be displayed during scroll and when the item is selected, and to fade out several seconds after the end of scroll except when the item is selected. An item in which identifier 3 is set is controlled by the list display processing module 131 to be continuously displayed irrespective of whether the item is selected or whether the item is being scrolled. An item in which identifier 4 is set is controlled by the list display processing module 131 to be displayed only when the item is selected.

Identifiers may be respectively written in items or may be written in a container containing a plurality of items.

In this manner, as to each item contained in each category, a content provider can set display for each item in a unified display form according to individual display states such as selected/unselected or a stop state/a scroll state.

In addition, as to an item which is desired to be highlighted during its selected state, a function which can recognize such item as an item to be highlighted by the list display processing module 131 during its selected state may be set in the item separately from an identifier, or such item may also be contained in a container in which a function is set which can recognize so as to cause the list display processing module 131 to perform highlighted display during the selected state.

As mentioned previously, an item in a container can modify its display method according to the internal state of an application. The manner of modification of the display method differs among layers.

The settings of each display mode are determined on the basis of layers and display states as shown in FIG. 11 by way of example.

Namely, a container displayed in each layer can be set to various display modes according to whether its display state is a stationary state, a scroll state, or a fast scroll state.

In FIG. 11, there are shown four display states according to the state chart mentioned above with reference to FIG. 9, i.e., a stationary state, a normal scroll state, a fast scroll state a, a fast scroll state b. It goes without saying, however, that the display states may be far more finely divided or a smaller number of display states may be used and a layer or layers may also be provided below the third layer. The settings of the display modes may be freely determined, for example, in such a manner that different display modes are used during the respective display states and in the respective layers and that the same display mode can be used during the same display state irrespective of the layers.

As shown in FIG. 12, the display scale, transmittance, display hue and the like of each item can be individually set on the basis of the display modes mentioned above with reference to FIG. 11 and the identifiers associated with the respective items, as well as according to whether the corresponding container is in a selected state or in an unselected state.

Specifically, for example, a container corresponding to item icons arranged in the first layer in the stationary state is displayed in a display mode A. Accordingly, when the container is selected, from among the items contained in the container, each item in which identifier 1 is written is displayed with a scale of 1.0× and a transmittance of 100%, each item in which identifier 2 is written is displayed in full color with a transmittance of 100%, and each item in which identifier 3 or 4 is written is displayed in black and with a transmittance of 100%. When the container is unselected, from among the items contained in the container, each item in which identifier 1 is written is displayed with a scale of 1.0× and a transmittance of 100%, each item in which identifier 2 or 4 is written is unselected and hence undisplayed, and each item in which identifier 3 is written is displayed in gray with a transmittance of 100%.

In addition, for example, containers which respectively correspond to item icons arranged in the second and third layers in the stationary state are displayed in a display mode B. Accordingly, when such container is selected, from among the items contained in the container, each item in which identifier 1 is written is displayed with a scale of 1.0× and a transmittance of 100%, each item in which identifier 2 is written is displayed in full color with a transmittance of 100%, each item in which identifier 3 is written is displayed in black and with a transmittance of 100%, and each item in which identifier 4 is written is displayed in gray with a transmittance of 80%. When the container is unselected, from among the items contained in the container, each item in which identifier 1 is written is displayed with a scale of 1.0× and a transmittance of 100%, each item in which identifier 2 or 4 is written is unselected and hence undisplayed, and each item in which identifier 3 is written is displayed in gray with a transmittance of 20%.

In addition, for example, containers which respectively correspond to item icons arranged in the second and third layers in the normal scroll state and item icons arranged in the first layer in the fast scroll state a are displayed in a display mode C. Accordingly, when such container is selected, from among the items contained in the container, each item in which identifier 1 is written is displayed with a scale of 1.2× so as to stand out more than the other icons during scroll, and with a transmittance of 100%, each item in which identifier 2 is written is displayed in full color with a transmittance of 80%, and each item in which identifier 3 or 4 is written is displayed in gray with a transmittance of 80%. When the container is unselected, from among the items contained in the container, each item in which identifier 1 is written is displayed with a scale of 1.0× and a transmittance of 20%, each item in which identifier 2 or 3 is written is displayed in gray with a transmittance of 20%, and each item in which identifier 4 is written is unselected and hence undisplayed.

Similarly, detailed display settings can be configured for each of the other display modes on the basis of each of the identifiers according to whether the containers are selected or unselected.

The setting method mentioned above with reference to FIG. 12 is merely one example, and the kinds of parameters to be selected for the display settings as well as the values of the detailed display settings such as scale, transmittance or display color setting are appropriately designable matters. Accordingly, it goes without saying that parameters for display settings other than those mentioned above with reference to FIG. 12 may be selected and that the settings of scale, transmittance or display color can also be configured with values other than those shown in FIG. 12.

In addition, the setting method mentioned above with reference to FIG. 12 has been described as performing setting of scale, transmittance or display color on the basis of the identifiers. However, in addition to the settings of transmittance or display color for each of the identifiers, the settings of transmittance or display color in the case of no identifier may also be configured for each of the display modes.

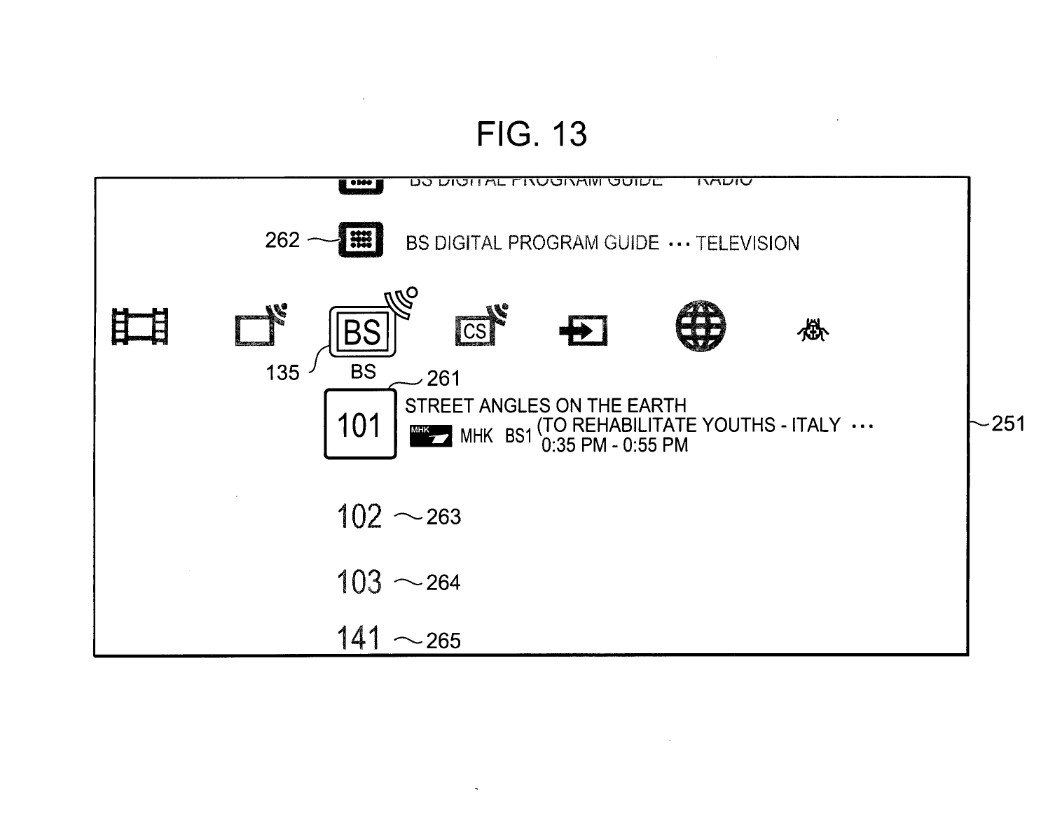

Specific examples of display of GUI screens and containers will be described below with reference to FIGS. 13 to 21.

FIG. 13 shows a GUI screen 251 which is not scrolled in a stationary state with the BS icon 135 selected as a category icon and a 101 icon 261 selected as an item icon.

The GUI screen 251 is in the stationary state in the first layer, and each item icon displayed on the GUI screen 251 corresponds to the display mode A as mentioned above with reference to FIG. 11 and the scale, transmittance and hue of each item of containers which respectively correspond to selected items and unselected items are determined on the basis of an identifier written in each item, in accordance with the table shown in FIG. 12. For example, from among the items contained in a container corresponding to an item BS DIGITAL PROGRAM GUIDE icon 262, the text “BS DIGITAL PROGRAM GUIDE —TELEVISION” displayed in the content title container display area 212 is labeled with identifier 3 and is displayed in gray hue with 20% transmittance. In contrast, even if items other than icons are contained in containers which respectively correspond to an item 102 icon 263, an item 103 icon 264 and an item 141 icon 265, the items are labeled with identifier 2 or identifier 4 and are undisplayed during the stationary state.

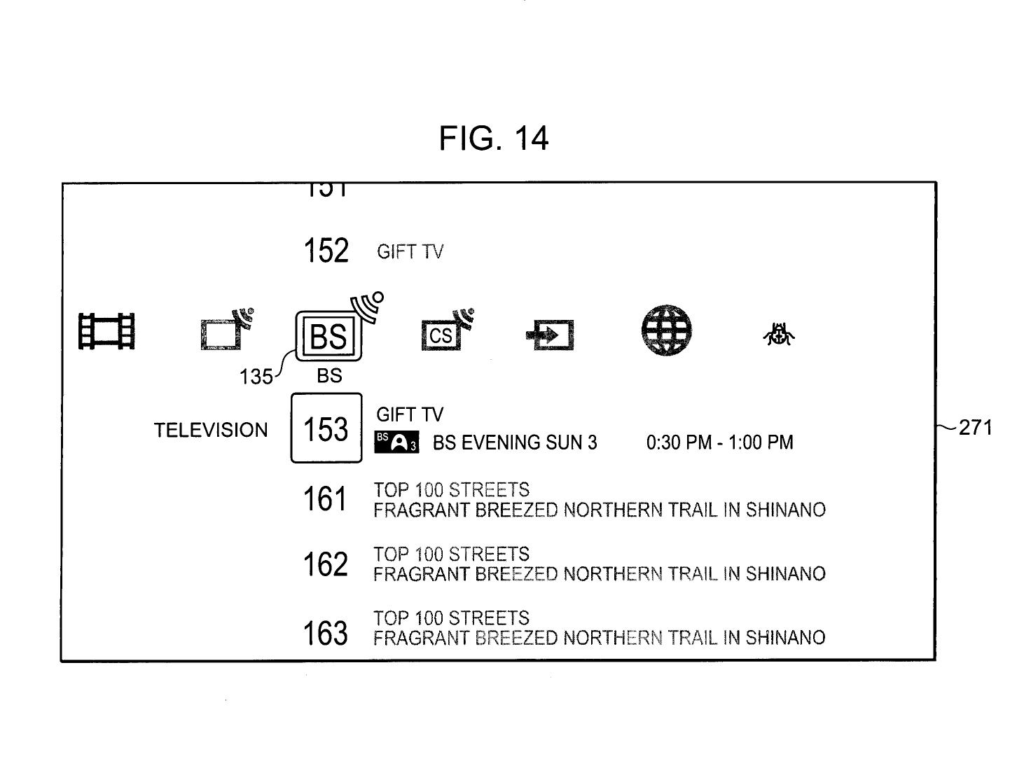

Then, when scroll is started on the GUI screen 251 in the stationary state shown in FIG. 13, a GUI screen 271 which is in the normal scroll state appears as shown in FIG. 14, and from among the items contained in containers respectively corresponding to items displayed on the GUI screen 271, items in which identifier 1, identifier 2 or identifier 3 is written are displayed in the display form based on the table of FIG. 12 irrespective of whether the items are selected or unselected. However, an item in which identifier 4 is written is displayed only during a selected state (i.e., when it is moved to a location directly below a category icon).

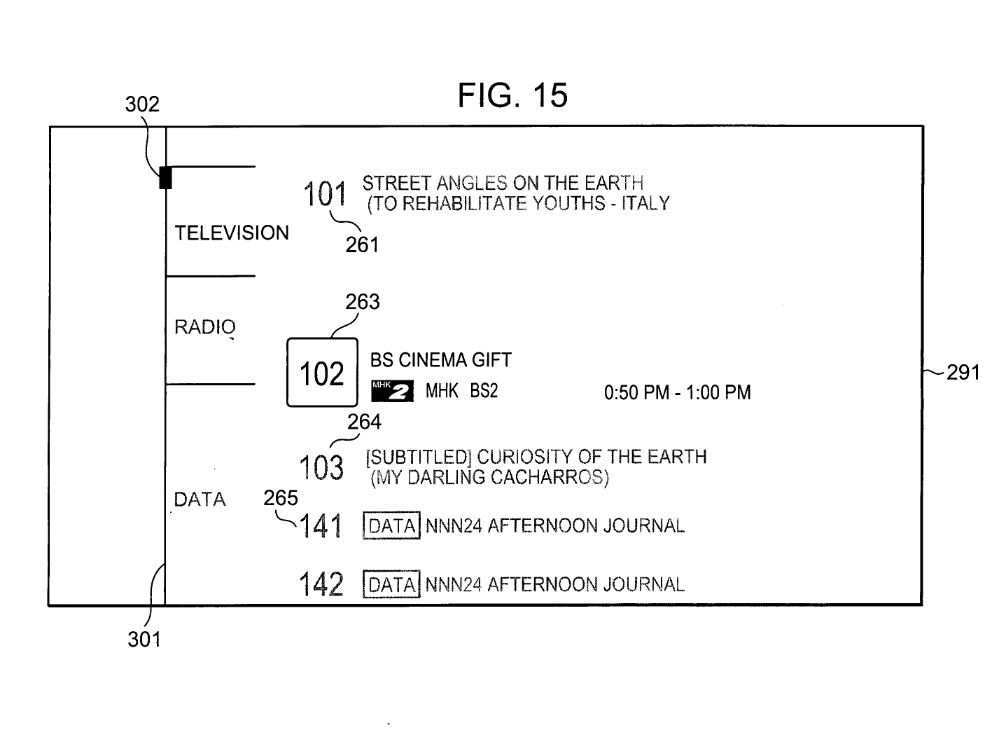

Then, when the fast scroll state b appears as shown in FIG. 15, a scroll bar 301 is displayed on the right side of the item icon arrangement on the screen, and a pointer 302 is displayed which indicates at which position the presently displayed one of a multiplicity of items is located. The scroll bar 301 and the pointer 302 are displayed, and from among items which constitute each container, only an item which should be displayed in the fast scroll state b is displayed. Accordingly, even if a container corresponding to a multiplicity of items is displayed in the item icon arrangement, the user can readily detect the desired item.

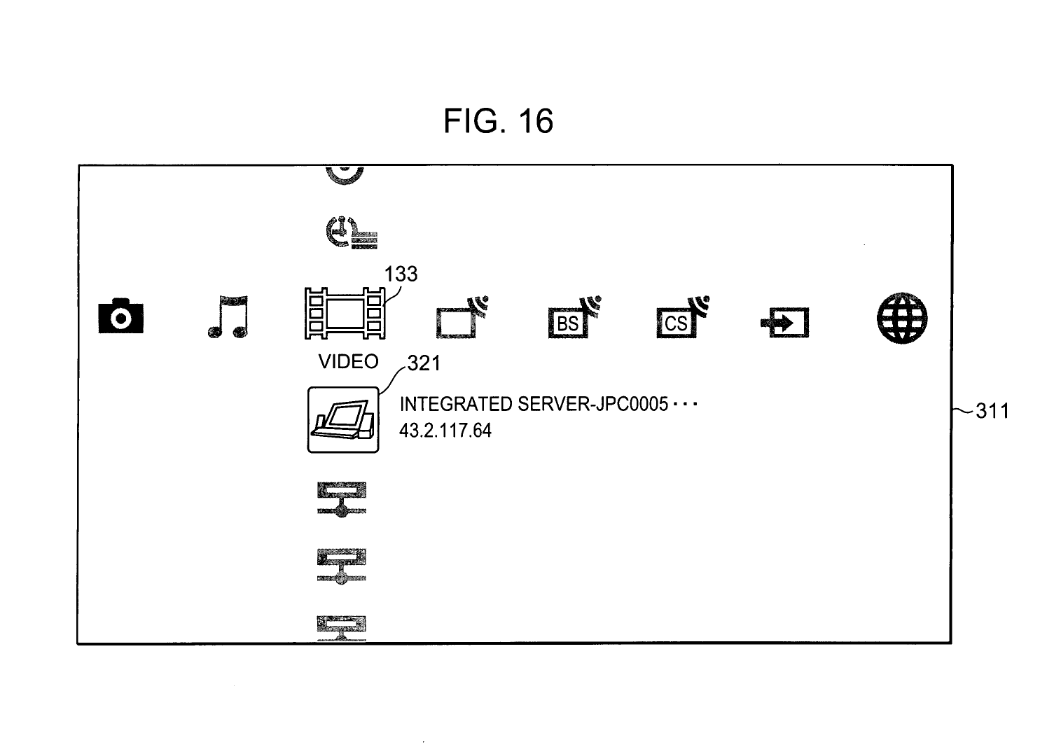

In addition, if the selection of the categories is changed, the entire category arrangement is moved to the right or the left and the category VIDEO desired by the user is selected on a GUI screen 331 as shown in FIG. 16 by way of example, and an item icon 321 located directly below the VIDEO category icon 133 is selected and the display state becomes the stationary state.

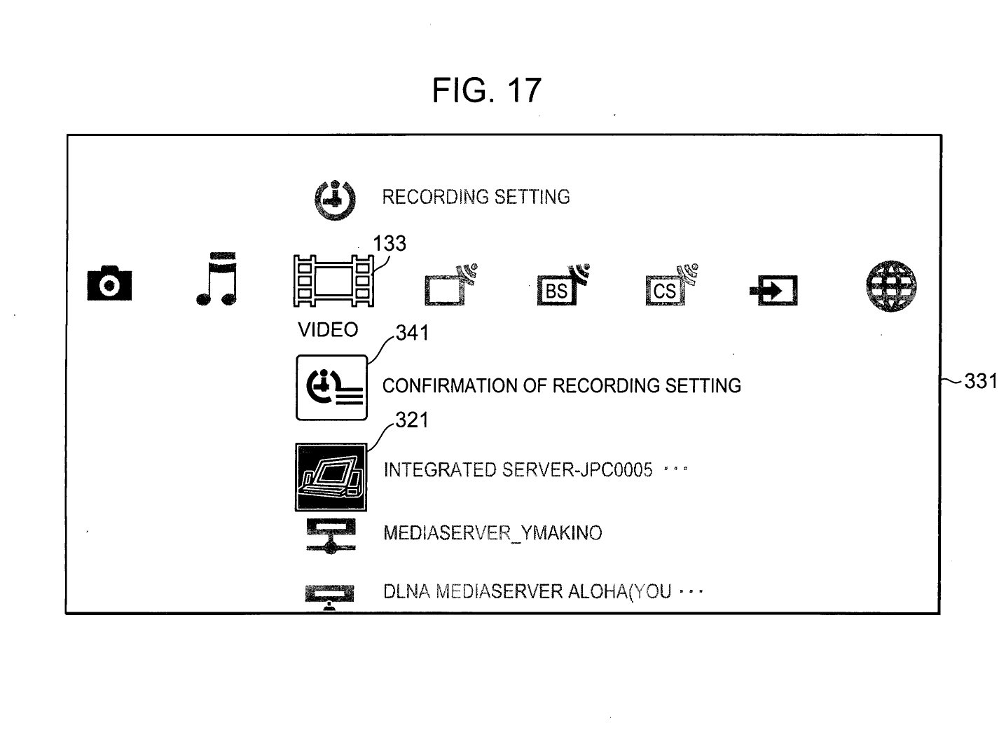

Then, when the user referring to the GUI screen 331 shown in FIG. 16 depresses the scroll button, the display state transitions from the stationary state to the GUI screen 331 which is in the normal scroll state as shown in FIG. 17. Individual containers on the GUI screen 331, such as an item icon 341 which is in its selected state, are displayed in the display mode C because the GUI screen 331 is in the normal scroll state in the first layer.

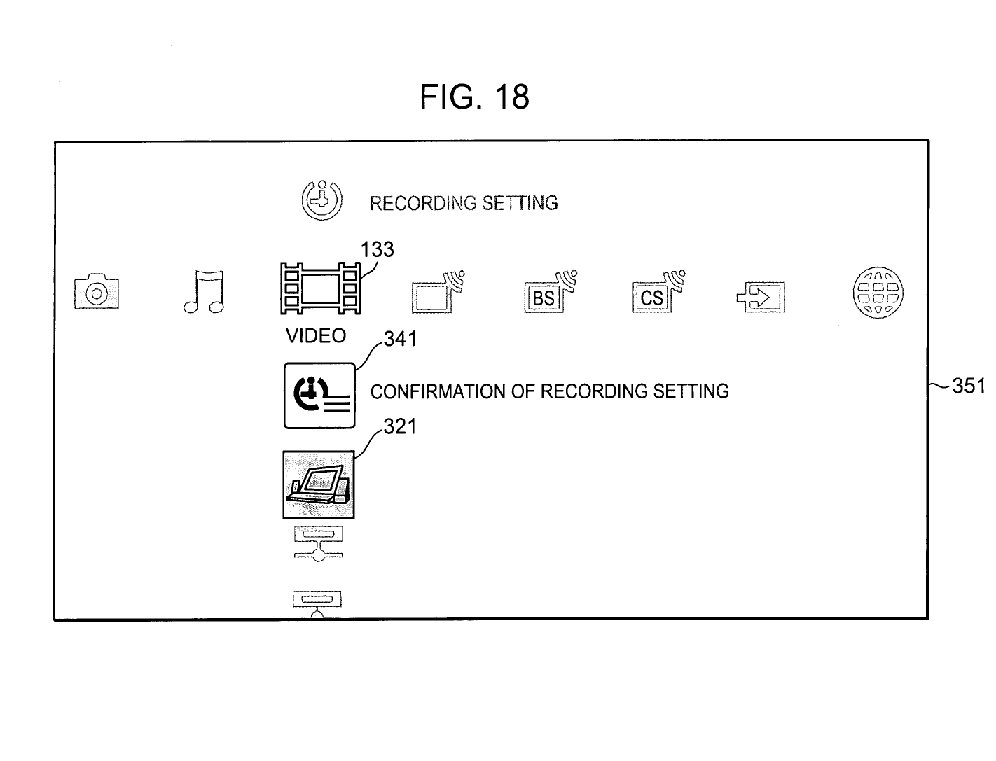

Then, after a predetermined time has elapsed since the display state transitions to the GUI screen 331 shown in FIG. 17 and the scroll button is released, if the scroll button is not yet depressed and a command to change layers or categories is not yet inputted, the display state transitions to a GUI screen 351 which is in the stationary state as shown in FIG. 18, and individual containers on the GUI screen 351 are in the stationary state in the first layer and are displayed in the display mode A.

Namely, items in each of which identifier 2 is written, when they are unselected, are displayed on the GUI screen 331 shown in FIG. 17 but not on the GUI screen 351 shown in FIG. 18. Items in each of which identifier 1 or identifier 3 are written, when they are unselected, are displayed on the GUI screen 331 shown in FIG. 17 and the GUI screen 351 shown in FIG. 18.

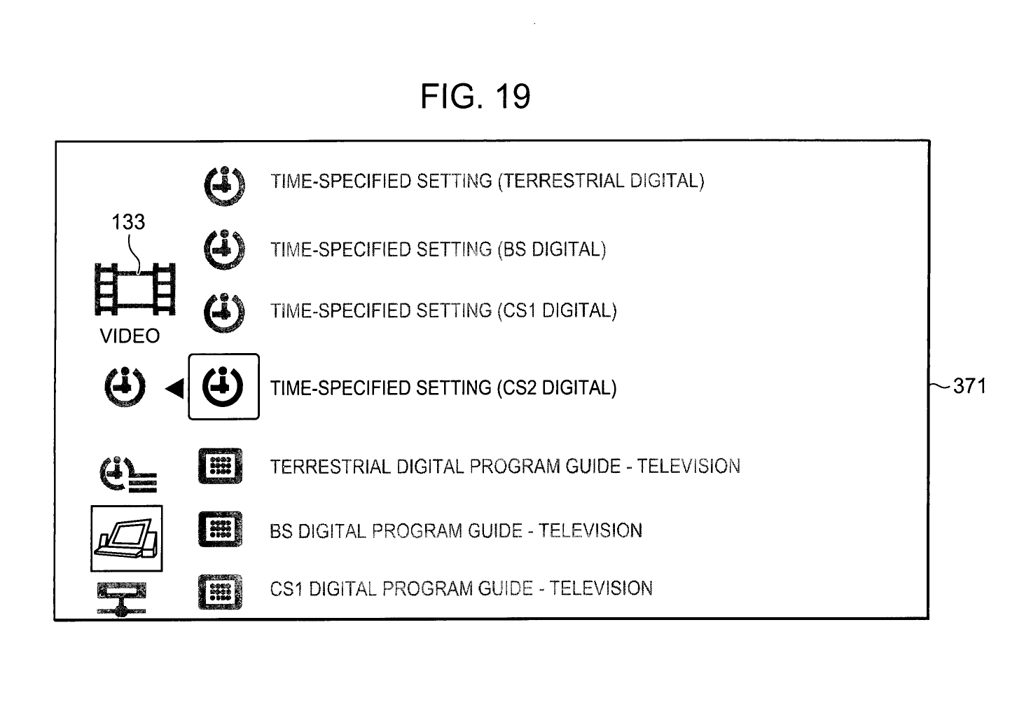

Then, if the item “RECORDING SETTING” is selected and determined, the containers of individual items in the second layer which hang from “RECORDING SETTING” are displayed as shown on a GUI screen 371 in FIG. 19.

At this time, no category icons are displayed except the selected VIDEO category icon 133, and the item icon arrangement in the first layer belonging to the VIDEO category is moved to the right on the screen, and an item icon arrangement in the second layer is displayed on the right side of the item icon arrangement. Since this state follows a state transition due to a command to change display layers, the display state is the stationary state. Accordingly, individual containers on the GUI screen 371 shown in FIG. 19 are displayed in the display mode B corresponding to the stationary state in the second layer.

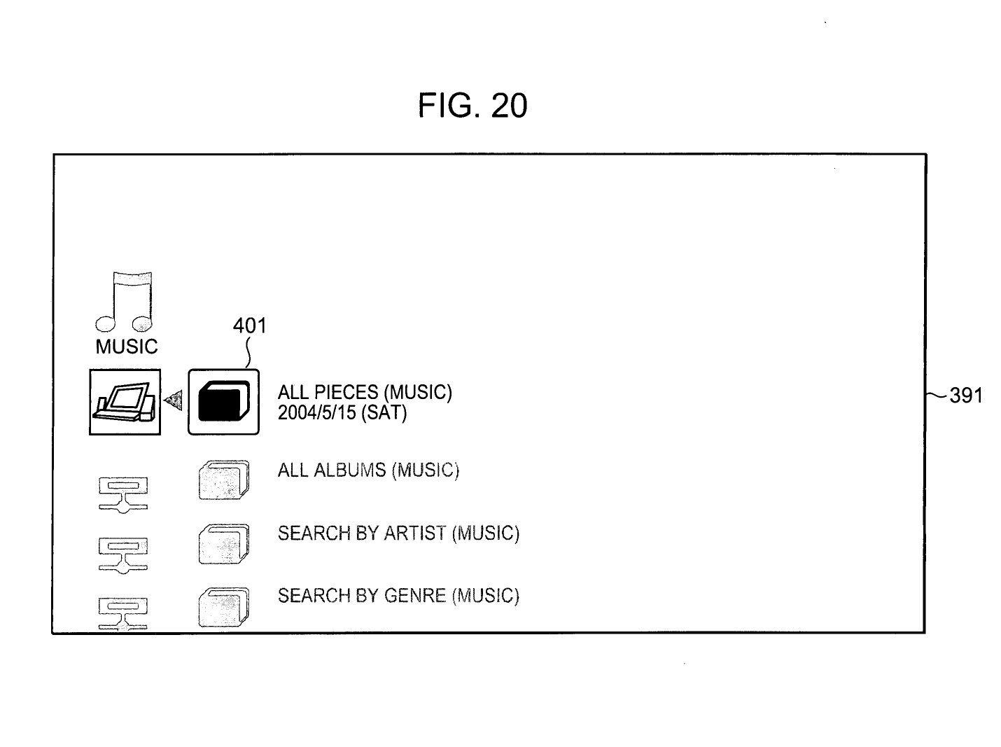

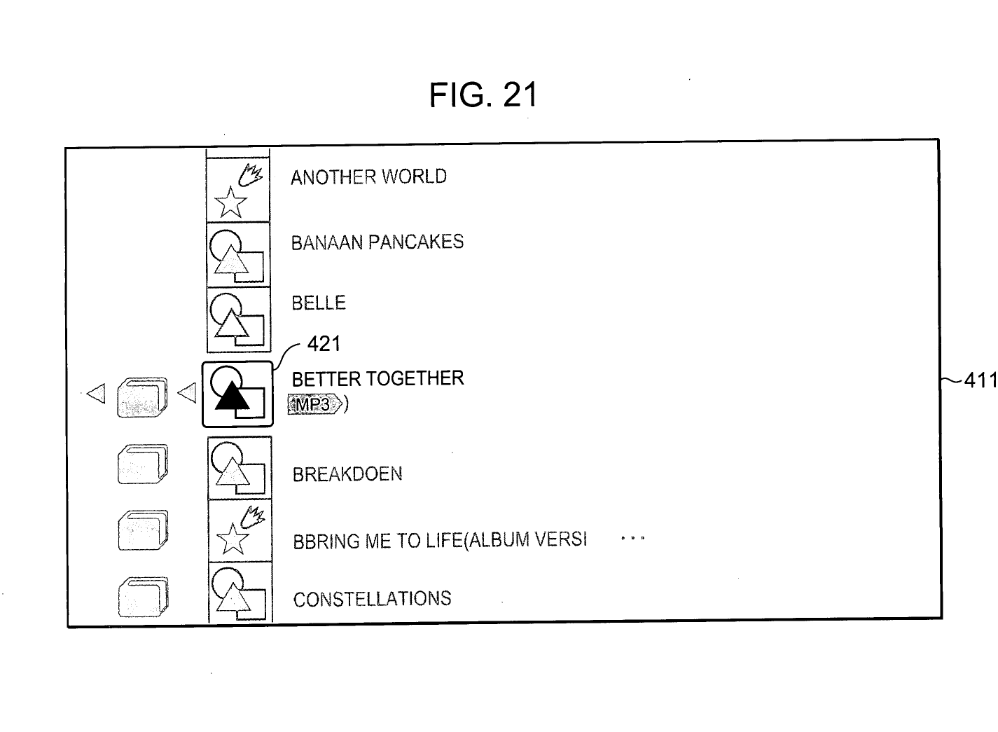

In addition, a lower layer may also be provided below the second layer. For example, if an item indicative of a predetermined server is selected from a category “MUSIC”, the containers of items in the second layer are displayed on a GUI screen 391 as shown in FIG. 20. In the case where the respective items corresponding to these containers are logical folder items in each of which music files are organized, when any one of the logical folder items (for example, an ALL PIECES (MUSIC) icon 401) is selected, containers in the third layer are displayed on a GUI screen 411 as shown in FIG. 21.

The individual containers on the GUI screen 391 shown in FIG. 20 are displayed in the display mode B corresponding to the stationary state in the second layer. On the GUI screen 411 shown in FIG. 21, the respective containers corresponding to icons including an item icon 421 which is in its selected state are displayed in the display mode B corresponding to the stationary state in the third layer.

As mentioned above, a displayed container, whether it is in the second, third or lower layer, includes a plurality of items similarly to that in the first layer, and an arbitrary identifier can be written in each of the items as needed. For an item in which an identifier is written, a display mode is determined on the basis of its internal state (such as the stationary or scroll state) as mentioned above with reference to FIG. 11, and the item is displayed in a detailed display form (for example, the display scale of an icon or the color or transmittance of a text, a symbol or the like) based on the identifier according to the display mode and whether the item is selected or unselected, as mentioned above with reference to FIG. 12.

Accordingly, even if a new display item is added to any layer of any item of any category, the added display item can be displayed in a GUI on the basis of similar definitions, and since identifiers can be written in individual items as needed, the display form of each of the items can be specified in detail on the basis of the internal state of display, the ordinal number of the layer, and whether the item is selected or unselected.

In addition, if no identifier is written in an item, the container of the item is displayed by a display method specified in advance on the basis of the display form of the container, irrespective of the internal state of display, the ordinal number of the layer, and whether the item is selected or unselected. Accordingly, even if a new display item is added to any layer of any item of any category, the added display item can be displayed in a GUI on the basis of similar definitions irrespective of the presence or absence of an identifier.

Item holding processing for displayably registering a new container will be described below with reference to the flowchart shown in FIG. 22.

In step S1, the list display information model module 133 determines whether a new content provider plug-in 102 has been added. The content provider plug-in 102 is newly added, for example, if a new application executable in the information processing apparatus 1 is installed, or if other apparatus is connected to the information processing apparatus 1 and the information processing apparatus 1 is capable of controlling any one of functions of the other apparatus, etc. If it is determined that no new content provider plug-in 102 has been added, the process proceeds to step S4 which will be described later.

If it is determined in step S1 that a new content provider plug-in 102 has been added, the list display information model module 133 acquires in step S2 root containers (as mentioned above with reference to FIG. 7) corresponding to the respective items contained in the added content provider plug-in 102, and information on items constituting various containers, as well as layer information on each of the items. The layer information is information indicating to which layers the corresponding items belong, respectively. Identifiers as mentioned above with reference to FIG. 10 are written as needed in the information on the various containers each including one or a plurality of items.

In step S3, the list display information model module 133 supplies the acquired root containers and the information on the items constituting the various containers as well as the layer information on each of the items to the list display processing module 131. The list display processing module 131 holds the supplied items in the GUI parts management section 103 as GUI parts.

If it is determined in step S1 that no new content provider plug-in 102 has been added, or after the completion of step S4, the list display information model module 133 determines in step S4 whether or not the addition of items has been notified by adding content to any of the content provider plug-ins 102 or the like. The content is added in he content provider plug-in 102, for example, if a new EPG is held in the EPG holding section 41, or if a received broadcasting program is recorded, or if new content such as new still image, moving picture image or music is acquired from other apparatus connected to the external input/output interface 37. If it is determined in step S4 that the addition of items has not been notified, the process is completed.

If it is determined in step S4 that the addition of items has been notified, the list display information model module 133 acquires in step S5 root containers (as mentioned above with reference to FIG. 7) corresponding to the respective added items, and information on items constituting various containers, as well as layer information on each of the items. Identifiers as mentioned above with reference to FIG. 10 are written as needed in the information on the various containers each including one or a plurality of items.

In step S6, the list display information model module 133 supplies the acquired root containers and the information on the items constituting the various containers as well as the layer information on each of the items to the list display processing module 131. The list display processing module 131 holds the supplied items in the GUI parts management section 103 as GUI parts, and the process is completed.

Through this processing, if a new content provider plug-in 102 is added or contents to be managed by any of the content provider plug-ins 102 are added, the root containers of items to be additionally displayed and items constituting containers are acquired, and GUI parts are held.

More specifically, in the case where a new content provider plug-in 102 is added because, for example, a new application executable in the information processing apparatus 1 is installed, or the information processing apparatus 1 is connected to other apparatus and the information processing apparatus 1 becomes capable of controlling new function of the other apparatus connected thereto, or the like, the list display model module 133 acquires a root container of items to be additionally displayed and items constituting the container, which are generated by the added content provider plug-in 102. These GUI parts are stored in the GUI parts management section 103. Furthermore, if there is added a content managed by the corresponding content provider plug-in 102 because, for example, a new EPG is held in the EPG holding section 41, or if a received broadcasting program is recorded, or if new content such as new still image, moving picture image or music is acquired from other apparatus connected to the external input/output interface 37, the content provider plug-in 102 generates a root container of items to be additionally displayed and items constituting the container, in response to the added content. The list display model module 133 acquires a root container of items to be additionally displayed and items constituting the container, which are additionally generated. These GUI parts are stored in the GUI parts management section 103.

Display processing of a GUI screen to be executed by the use of the GUI parts held in the GUI parts management section 103 through the above-mentioned processing on the basis of a user's operation input and a transition between scroll states which are acquired by the processing of the operation input acquisition and scroll state management module 132 will be described below with reference to the flowchart shown in FIG. 23.

In step S21, the list display processing module 131 determines whether update of the display state is needed, for example, when the user changes the selection of categories or items or inputs a scroll operation, on the basis of information supplied from the operation input acquisition and scroll state management module 132. If it is determined in step S21 that update of the display state is not needed, the processing of step S21 is repeated until it is determined that update of the display state is needed.

If it is determined in step S21 that update of the display state is needed, the list display processing module 131 in step S22 searches for an item to be displayed on the display screen after the update of the display state.

In step S23, the list display processing module 131 determines whether an item to be displayed on the display screen after the update of the display state has been found. If it is determined in step S23 that no item has been found, the process is completed.

If it is determined in step S23 that the item has been found, the list display processing module 131 in step S24 determines a display mode from the layer and the state of the item as mentioned above with reference to FIG. 11.

In step S25, the list display processing module 131 selects one GUI part whose display is to be set, from among GUI parts which are targets whose display states are to be updated.

The list display processing module 131 determines in step S26 whether an identifier as mentioned above with reference to FIG. 10 is written in the GUI part which is a target whose display state is to be updated. If it is determined in step S26 that an identifier is not written, the process proceeds to step S30 which will be described later.

If it is determined in step S26 that an identifier is written, the list display processing module 131 in step S27 searches for details of the display mode of the target GUI part in the table described above with reference to FIG. 12, on the basis of the written identifier and the display mode.

The list display processing module 131 determines in step S28 whether details of the display mode of the target GUI part has been searched for.

If it is determined in step S28 that details of the displayed mode of the target GUI part has been searched for, the list display processing module 131 in step S29 sets modification of the details of the display mode of the target GUI part.

If it is determined in step S26 that an identifier is not written or it is determined in step S28 that details of the display mode of the target GUI part has not been searched for or after the completion of the processing of step S29, the list display processing module 131 determines in step S30 whether there remains a GUI part which becomes a target whose display state is to be updated. If it is determined in step S30 that there remains a GUI part, the process returns to step S25, and step S25 et seq. are repeated.

If it is determined in step S30 that there remains no GUI part, the list display processing module 131 in step S31 supplies the detailed settings of the display forms of the respective GUI parts after the update of their display states to the drawing processing section 104. The drawing processing section 104 executes drawing processing of items on the basis of the set display forms, and on the basis of the transition of the display states, displays the scroll bar 301 and the pointer 302 as mentioned above with reference to FIG. 15 by way of example, or changes the display position of the item icon arrangement and draws a GUI screen as mentioned above with reference to FIG. 19 and the like.

In step S32, the drawing processing section 104 supplies the drawn items to the display image generation and output section 40 and the display image generation and output section 40 displays the GUI screen, and the process is completed.

Through the above-mentioned processing, detailed display settings are performed according to the layer of each item, whether the display state is the stationary state or the scroll state, whether the item is selected or unselected, and whether an identifier is written in each item, and if an identifier is written, according to which identifier is written. Accordingly, even if various contents are displayed in list, a wide variety of user-friendly display can be provided while their display forms are unified.

As described hereinabove, according to the embodiment of the present invention, it is possible to exclude the direct dependence between modules constructing the entire display system and ensure the portability of the modules, and it is possible to realize unified display specifications of contents according to the internal state of an application for performing display processing which varies due to user's operation and the like, while maintaining a maximum degree of freedom of construction of GUI parts which represent various contents.

The above-mentioned sequence of processing can also be executed by software. A program which constitutes the software is installed from a recording medium into a computer incorporated in dedicated hardware, or into, for example, a general-purpose personal computer capable of executing various functions by the installation of various kinds of programs.

This recording medium, as shown in FIG. 1, is made of a removable medium 50 on which a program is recorded and which is distributed separately from a computer in order to provide the program for a user, for example, a magnetic disk (including a flexible disk), an optical disk (including a CD-ROM (Compact Disk-Read Only Memory) and a DVD (Digital Versatile Disk)), a magneto-optical disk (including an MD (Mini-Disk) (trademark)), or a semiconductor memory. Otherwise, the recording medium is made of the program RAM/ROM 53, a hard disk drive or the like on which a program is recorded and which is provided for a user in a state incorporated in a computer.

In the present specification, the steps which describe the program recorded on the recording medium include not only processing which is performed in the above-described order in a time-series manner, but also processing which is not necessarily processed in a time-series manner but is executed in parallel or individually.

In the present specification, the term “system” represents the entire apparatus made of a plurality of devices.

The above-described embodiment of the present invention is not limitative, and can be modified in various ways without departing from the spirit and scope of the present invention.

The present invention contains subject matter related to Japanese Patent Application JP 2005-238280 filed in the Japanese Patent Office on Aug. 19, 2005, the entire contents of which being incorporated herein by reference.

What is claimed is:

1. An information processing apparatus capable of handling a plurality of contents, comprising:
display information generation means for generating display information related to each of the contents;
state management means for managing a display state of the display information;
display layer management means for managing a display layer of the display information; and
display control means for controlling display of the display information on the basis of the display state managed by the state management means and the display layer of the display information managed by the display layer management means.

2. An information processing apparatus according to claim 1, wherein:
the display information includes for each display item a plurality of pieces of display parts information having a tree structure.

3. An information processing apparatus according to claim 2, wherein:
the display information or the display parts information is capable of containing an identifier,
the display control means controls the display of the display information on the basis of the identifier.

4. An information processing apparatus according to claim 2, wherein:
the display information or the display parts information is capable of containing an identifier,
the display control means sets a display mode on the basis of the display state managed by the state management means and the display layer of the display information managed by the display layer management means, and sets detailed display settings on the basis of the set display mode, whether the display information is selected, and the identifier.

5. An information processing apparatus according to claim 1, wherein:
the state management means acquires an operation input by a user,
the display state managed by the state management means is information indicative of whether the display of the display information is being scrolled, on the basis of the operation input by the user.

6. An information processing method for an information processing apparatus capable of handling a plurality of contents, the method comprising:
generating display information related to each of the contents;
managing a display state of the display information; and
controlling display of the display information on the basis of the managed display state and a display layer of the display information.

7. An information processing method according to claim 6, further comprising:
searching details of a display form of the display information on the basis of an identifier, the identifier being contained in the display information;
in the controlling of the display of the display information, the display of the display information is controlled on the basis of the display state and the display layer of the display information as well as the details of the display form of the display information searched for.

8. A program executable by a computer constructed to handle a plurality of contents, the program causing the computer to execute processing comprising:
generating display information related to each of the contents;
managing a display state of the display information; and
controlling display of the display information on the basis of the managed display state and a display layer of the display information.

9. A recording medium on which the program according to claim 8 is recorded.

10. An information processing apparatus capable of handling a plurality of contents, comprising:
a display information generator adapted to generate display information related to each of the content;
a state manager adapted to manage a display state of the display information;
a display layer manager adapted to manage a display layer of the display information; and
a display controller adapted to control display of the display information on the basis of the display state managed by the state manager and the display layer of the display information managed by the display layer manager.
